(19) United States
(12) Patent Application Publication
(10) Pub. No.: US 2010/0138402 A1
(43) Pub. Date: Jun. 3, 2010

(54) METHOD AND SYSTEM FOR IMPROVING UTILIZATION OF HUMAN SEARCHERS

(75) Inventors: Michael Burroughs, Indianapolis, IN (US); Thomas E. Cooper, Indianapolis, IN (US); John T. Ellis, Fishers, IN (US)

Correspondence Address: STAAS & HALSEY LLP, SUITE 700, 1201 NEW YORK AVENUE, N.W., WASHINGTON, DC, 20005, US

(73) Assignee: ChaCha Search, Inc., Carmel, IN (US)

(21) Appl. No.: 12/629,500

(22) Filed: Dec. 2, 2009

Related U.S. Application Data
(60) Provisional application No. 61/119,205, filed on Dec. 2, 2008.

(51) Int. Cl. G06F 17/30

(52) U.S. Cl. 707/706; 707/759; 707/723; 707/E17.017; 707/E17.108

(57) ABSTRACT

A method and system for improving utilization of human searcher(s) in a search system including utilizing a processing such as Natural Language Processing to improve the ability of the search system to recognize an intent of a user request, provide information to an expeditor to respond to queries, and automatically route a query to a relevant and qualified searcher. Using NLP, a request is processed to allow improved use of automated responses, more effective use of the expeditor, and more effective use of search specialists.

### CROSS-REFERENCE TO RELATED APPLICATIONS

This application is related to and claims the benefit of U.S. application Ser. No. 12/275,864, Attorney Docket No. 1918.1034, inventor Scott A. Jones, et al., titled METHOD AND SYSTEM FOR IMPROVING UTILIZATION OF HUMAN SEARCHERS, filed Nov. 21, 2008, U.S. application Ser. No. 12/434,385, Attorney Docket No. 1918.1036, inventor Scott A. Jones, et al., titled METHOD AND SYSTEM FOR IMPROVEMENT OF REQUEST PROCESSING, filed May 1, 2009, and U.S. Provisional Application Ser. No. 61/119,205, Attorney Docket No. 1918.1064, inventor Mike Burroughs, et al., titled METHOD AND SYSTEM FOR IMPROVING UTILIZATION OF HUMAN SEARCHERS, filed Dec. 2, 2008 the disclosures of which are incorporated herein by reference in their entirety.

### BACKGROUND

1. Field

Embodiment(s) described herein relate to search engine technologies including human-assisted search engines and, more particularly, to a method and system of processing a request for information using a combination of automated processing and human intelligence.

2. Description of the Related Art

A human assisted search service can provide a more natural and effective response to a request for information. Natural language queries may be interpreted, and a response to a query may be obtained by a person. This may be particularly desirable if a query is submitted using a mobile device which may have limited capabilities. In particular, the use of SMS or voice to submit a request for information may be more readily accepted when a human-assisted response is provided.

Human assisted search services have found greater acceptance than purely automated services due at least in part to a higher answer quality, increased ease of use, and generalized response capability. However human-assisted search systems must generally have a low cost to serve a user in order to find broad acceptance. For example, pay-per-use systems such as any question answered (AQA), or lnfonxx Knowledge Generation Bureau have answered a few million queries per year, while free services such as ChaCha® have answered tens of millions of queries per month.

Regardless of whether a human assisted search system is pay-per-use or advertising supported, the cost to provide a response to a query is a direct impact to profitability. However, the ability to reduce cost is quite difficult. Comparison of a user request to a database of previous requests may be ineffective even if the database of previous queries is large. Factors including such as the combinatorial nature of human languages, spelling, slang or colloquialisms, etc. may impair the ability to match a query to a stored query. If a query is passed to a person, it may be difficult for the person to select an answer without having knowledge of the process applied to the query.

In light of the above and other problems existing in typical search systems, there is a need for a system and method for optimizing use of human searchers utilizing natural language processing.

### SUMMARY

A method and system of improving utilization of human searcher(s) including using Natural Language Processing to recognize an intent of a user request, provide information to an expeditor to respond to queries, and automatically route a query to a relevant searcher.

A computer-implemented method is provided herein that executes an operation including receiving a request for information, executing a processing with respect to the request including comparing a predefined query pattern, correcting spelling, substituting words, removing signatures using information of stored requests, creating automatically an annotation graph for the request, selecting a category, obtaining queries determined to match the annotation graph using an index of queries, calculating a matching function comparing the queries to the annotation graph, calculating a rating of a search result associated with the queries, ranking the queries based on the matching function, ranking the search results based on the rating and providing a highest ranked search result responsive to the request.

A system embodiment, methods, data structures and interfaces for operating the embodiments are disclosed.

### BRIEF DESCRIPTION OF THE DRAWINGS

Aspects and advantages of the invention will become apparent and more readily appreciated from the following description of the embodiments, taken in conjunction with the accompanying drawings, of which:

FIG. 1 is a block diagram of a system embodiment.

FIG. 2 illustrates a flow diagram of a process of performing a search.

FIG. 3 illustrates a flow diagram of a process of responding to a request.

FIG. 4 illustrates a flow diagram of a process of responding to a search result.

FIG. 5 illustrates a database record for a raw query.

FIG. 6 illustrates a database record for a vetted query.

FIG. 7 illustrates a flow diagram of a process of performing a search.

FIG. 8 illustrates a flow diagram of a process of processing a search request.

FIG. 9 illustrates a flow diagram of a process of reusing a search result.

FIG. 10 illustrates a flow diagram of a process of routing a search request.

FIG. 11 illustrates a flow diagram for vetting a request.

FIG. 12 illustrates a query processing GUI for preparing a search for a searcher.

FIG. 13 illustrates a query processing GUI for selecting a search result.

FIG. 14 illustrates a GUI for selecting a search result provided by a resource.

FIG. 15 illustrates a GUI for selecting a search result provided by a resource.

### DETAILED DESCRIPTION OF THE PREFERRED EMBODIMENTS

Reference will now be made in detail to the present embodiments discussed herein, examples of which are illustrated in the accompanying drawings, wherein like reference numerals refer to the like elements throughout. The embodiments are described below to explain the disclosed system and method by referring to the figures. It will nevertheless be understood that no limitation of the scope is thereby intended, such alterations and further modifications in the illustrated device, and such further applications of the principles as illustrated therein being contemplated as would normally occur to one skilled in the art to which the embodiments relate. As used herein words importing the singular shall include the plural and vice versa unless specifically counter indicated.

A method and system for improving utilization of human searcher(s) using natural language processing (NLP) includes using NLP to process an initial query. Should the NLP be unable to determine an intent of a customer, a system may utilize information from the NLP process to determine if a request may be handled by a human assistant specializing in query processing or ‘expediter’ or may be routed directly to a search specialist or ‘searcher’ to perform a search. NLP results may be used to assist an expediter in using a toolset which may enable a rapid and repeatable response to various user requests. Subsequent to processing by an expediter, NLP may be applied to a request in order to determine if a previous answer may be provided and/or if a searcher should obtain a search result.

Processing such as algorithmic processing of a request is applied in order to optimize the use of human guides. A request is first compared to standard templates to determine if the request conforms to an automated response format. If a query is not found to conform to a recognized format, the query is analyzed using NLP. NLP may be used to remove information from and/or augment a query such that the query may more easily be categorized and/or associated with a recognized format.

Subsequent to the NLP process, a request is compared to a database of requests which may be used to determine whether a search result is available which may be used to provide a response to the request. If it is determined that a search result is not available, the results of NLP may be used to determine if an ambassador guide or a searcher should receive the request.

A method and system of improving utilization of human searcher(s) is disclosed. A query is received by a search system, which may apply NLP to the query. If a query is received, it may be processed to determine if the query is a formulaic or “keyword query”. A “keyword query” is a query which begins with and/or includes a word and/or phrase which indicates that the query is intended for automated processing. For example, a query which begins with the word “weather” and includes a noun phrase which is recognized as a location may be determined to be a keyword query. A request may be determined to be a “keyword query” based on one or more factors including when the request contains at least one word pre-identified by a user (who may be an administrator) as being a cause for an automated processing, based on previous association of the query with automated processing, etc.

NLP of a query may be applied to make the query easier to interpret and/or to remove extraneous information. For example, spelling correction, grammar correction, word substitution, and signature removal may be applied to improve the probability that a query may be recognized automatically and/or using a human assistant. NLP may include named entity analysis. A ‘named entity’ may be any noun or noun phrase which is associated with a proper noun. For example, a database of celebrities, sports figures, cities, neighborhoods, etc. may be used to obtain a lexicon for named entity analysis.

NLP of a query may include categorization and reformatting of a query. For example, a Bayesian model for categorization may be applied, based on factors such as noun phrases associated with a query which may be associated with an index of categories. In at least one embodiment, grammar of a query may be examined to apply parts of speech tags to the query.

After a query has been processed using NLP, the query may be compared to templates which may allow a query to be answered automatically. If an answer can not be provided programmatically (or automatically), a processed query may be compared to a database of stored queries, and if it is determined that a query is a match to a stored query, an answer associated with the stored query may be provided responsive to the query. While a query is being described as being compared to a template, the present invention is not limited thereto. For example, a query may be compared to one or more formatted, predefined or standardized queries including to determine whether the query can be automatically answered using one or more of the responses of matching quer(ies).

A query may be analyzed to determine whether an expediter is to be presented with the query. If an expediter is presented with the query, a processed query and a user query maybe presented to the expediter. An expediter may reformat a query, associate a location with a query and/or may categorize a query, and a resulting query may be processed to obtain queries which may match the resulting (revised or reformatted) query. If an expediter has modified and/or augmented a query, parameters for selection of an answer and/or matching of a query to a stored query may be modified. An expediter may override a system matching.

If a query is directed to a searcher, the searcher may receive information of an unprocessed, a NPL processed, and an expediter processed forms of a query. A categorization associated with a query may indicate whether an expediter has selected the categorization.

A system embodiment, methods, data structures and interfaces for operating the embodiments are described below in detail.

A “user” may be any person or entity which may submit a request or search request. A request or search request or query is information which may be submitted using any communication service which may be able to access a search system as further described herein below. A query may include text, a word, keywords, and/or a fully formed question. A query may include any media which are compatible with an interface to a search service such as text, images, audio, video, URL's, etc.

A “guide” may be any person who may be compensated and/or may be a volunteer who may respond to a request. An “ambassador” or “expediter” is a guide who may perform processing of a request and/or a search result(s). A “searcher” is a guide who may perform an information search responsive to a request.

A “raw query” is a request submitted by a user, which may include any type of information provided by a user and/or associated with a user.

A “vetted query” includes a request which is associated with a category, a structured query, or otherwise qualified query.

A “structured query” is a question formulated according to a structured grammar. In at least one embodiment, a grammar construction required for a structured query is a question. A structured query may also be referred to as a “succinct query”.

An “identifier” or ID is a group of characters, numbers and/or other types of information which may be used to identify an item.

A “guided request” is a request which uses the assistance of one or more guides.

A “result” or “search result” is any information which may be provided responsive to a request. A search result includes but is not limited to any of an advertisement(s), a link to a web page, a message of any sort, image, audio, text, games, interactive media and/or software of any sort.

A “search resource” is any source of information which may be used to obtain a search result. A search resource includes automated and/or human-assisted systems, and any type of media and/or systems which may provide information. For example, web pages, search engines, data feeds, databases, a private archive, printed materials, etc. may be a search resource.

A “profile” is a group of one or more characteristics which may be associated with a person. Profile characteristics include but are not limited to demographic, geographic, personality, affiliations, areas of interest, historical actions, preferences, memberships, associations, etc.

In order to improve utilization of searchers, automation may be utilized. However, automated processing may degrade system performance as algorithmic analysis may not meet a needed level of confidence. However, a blended approach to use of human intelligence and algorithmic processing may provide a high quality user experience while making a human assisted system cost effective. In a human assisted system, Natural Language Processing (NLP) may be used in order to improve the content of a query prior to presenting the query to a human assistant or guide.

NLP may be used to correct errors, detect the language of a query, and to make other corrections including as is well established in the art. In the new system NLP is further used to estimate a match between a user request and a structured query. NLP is used to evaluate a quality of stored search results associated with a query in order to determine whether a stored result may be provided to a user. NLP is further used to optimize the use of ambassadors. If NLP determines a most probable type of query, an ambassador may be provided with tools associated with the most probable type of response. Likewise if a request is categorized with a high level of confidence and a structured query has been determined to match a user request with high probability, a request may be provided to a searcher without utilizing an ambassador.

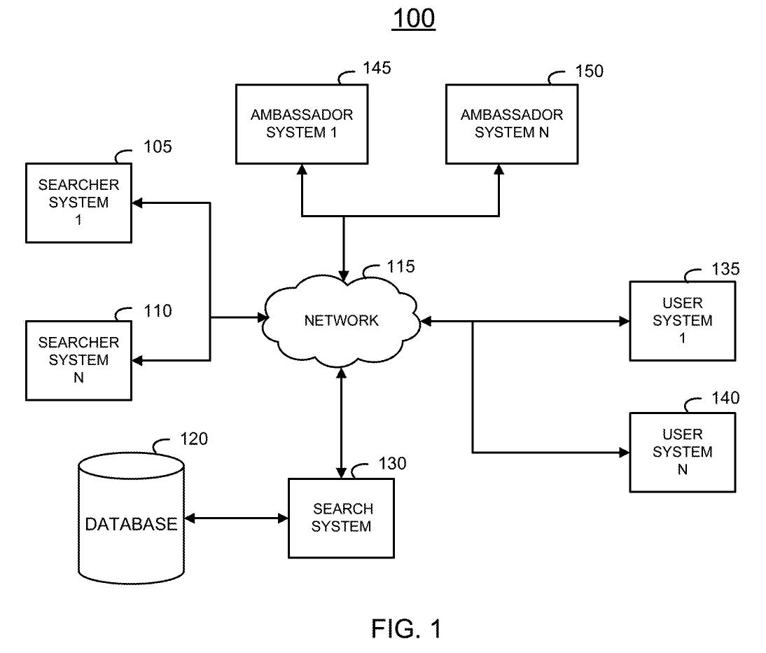

An exemplary system embodiment is illustrated in FIG. 1. As illustrated in FIG. 1, system 100 includes searcher systems 105, 110, a network 115 such as the Internet, a search system 130, user systems 135, 140, a database 120, which may comprise various records, and ambassador system 145, 150.

Each of the guide systems, that is, the searcher systems 105, 110 and the ambassador systems 145 and 150 can be operated by a guide to obtain a search result on behalf of a user located at a user system (e.g., the user systems 135, 140). While only a limited number of searcher (also referred to as a human searcher), ambassador (also referred to as a vetting guide or query vetting guide or expediter) and user (also referred to as an information seeker or requester) systems are depicted in FIG. 1, it is within the scope of the disclosure for multiple searcher, ambassador and user systems to be utilized.

The network 115 (FIG. 1) may be a global public network of networks (the Internet) and/or consist in whole or in part of one or more private networks and communicatively couples the searcher computer systems 105, 110, the ambassador systems 145, 150 and user computer systems 135, 140 with the other components of the system 100 such as the search system 130, and the database 120. The network 115 may for example include any or all of a wireless network(s) such as a cellular phone network, a WiMax network, a WiFi network, etc. a network such as the Public Switched Telephone Network (PSTN), and/or any other type of communication network.

The search system 130 allows interaction to occur between the searcher systems 105, 110, the ambassador systems 145, 150 and the user systems 135, 140. For example, a request can be transmitted from the user systems 135, 140 to the search system 130, where a request can be accessed by the searcher systems 105, 110 and/or the ambassador systems 145, 150. Similarly, a search result produced using the searcher systems 105, 110 or the ambassador systems 145, 150 in response to a request produced by the user systems 135, 140 may be transmitted to the search system 130, where it may be stored by the search system 130 and/or may be transmitted to the user systems 135, 140 and/or the ambassador systems 145, 150.

The user systems 135, 140 may include within the scope of the disclosure, any device through which an information seeker can submit a request to and/or receive information or search result from the search system 130. In one embodiment, the user system 135 may be a device configured for connection to a network and may run web browser software. Thus, the user systems 135, 140 may be a portable or laptop computer, a personal data assistant (PDA), a desktop computer such as a PC or Mac®, a workstation or a terminal connected to a mainframe, a specialized search apparatus, or a smart phone, etc. within the scope of the disclosure. Any device which can communicate using Internet Protocol (IP) may be a user system, a searcher system, and/or an ambassador system within the scope of the disclosure.

The search system 130 may include a gateway for voice communication and a speech-to-text system or other transcription device and/or personnel to facilitate access to the search system via voice communications such as through a land line phone, cellular phone, Voice over Internet Protocol and/or other telephonic device(s). Any device(s) which may be used to communicate using voice (speech) may be a user system, a searcher system and/or an ambassador system.

The search system 130 may include hardware and/or software interface to a system which provide communication services such as Instant Messaging (IM), email, Short Messaging Service (SMS), Enhanced Messaging Service (EMS), Multimedia Messaging Service (MMS), and/or other forms of messaging services. Any device which may communicate using such services may be a user system, a searcher system, and/or an ambassador system within the scope of the disclosure herein. A request may be submitted to the search system 130 using any or all communication services which are able to communicate with the search system 130.

Although the search system 130 is illustrated as a single system, the search system 130 may include any number of hardware systems, which may function as servers or other elements. The search system 130 may include one or more servers, computers, etc. For example, servers such as the PowerEdge® 2900 by Dell, or the BladeCenterJS22 by IBM, or equivalent systems might be used to implement elements of the search system 130. The search system may utilize an operating system (OS) such as Microsoft Windows XP, or Linux, etc. Voice routing and packet switching may be accomplished using well established technologies such as those provided by Cisco, or other networking companies. For example, a server functionality associated with any of the communication services identified herein above may be implemented to allow messages to be transmitted between the elements of the system 100. After being presented with the disclosure herein, one of ordinary skill in the relevant art will immediately realize that any viable computer systems or communication devices known in the art may be used as user systems, guide systems, ambassador systems, and/or to implement the search system 130.

The search system 130 is communicatively coupled with the database 120. As will be described herein in further detail below, the database includes data that is processed during operation of the embodiments. Although FIG. 1 illustrates the database 120 as a separate component of the system, the database 120 may be integrated with the alternate search system 130. Further, the records maintained in the database 120 may be stored in any typical manner, including in a Network Attached Storage (NAS), a Storage Area Network (SAN), etc. using any typical or proprietary database software such as DB2®, Informix®, Microsoft® SQLServer™ MySQL®, Oracle®, etc., and may also be a distributed database on more than one server. Elements of the database 120 may reside in any suitable elements of the system 100. For example, elements of the database 120 may be stored in any storage media accessible to a user system, a searcher system, and/or an ambassador system.

After being presented with the disclosure herein, one of ordinary skill in the art will readily appreciate that the computer systems of the embodiments can be any type of viable systems known in the art.

In the disclosed system and method, guides (searchers) and/or ambassadors (expediters) may be required to register with the search system 130, and in certain embodiments undergo training prior to being permitted to provide responses to requests submitted by a user utilizing the search system 130. In one embodiment, a prospective guide may also be invited to register as a guide with the search system 130. In such a system, a previously registered guide and/or an affiliate group may initiate the invitation process and thereby be designated as a sponsor for the invited guide. In one embodiment of the disclosed system and method, a prospective guide is sent an email invitation to register as a guide with the search system 130. The email invitation in one embodiment contains a link to a guide registration page and some indicia recognizable by the search system 130 as to the person or entity that invited a prospective guide to register so that upon registration the person or entity may be accredited with sponsorship of the invited guide.

Should a prospective guide elect to register as a guide with the search system 130, the prospective guide may for example initiate a registration process by selecting a link that directs the guide's web browser to a URL of a guide registration page generated by a web server function of the search system 130 (FIG. 1). While registration of a prospective guide is described with respect to the search system 130 providing pages to a browser, the present invention is not limited to any particular configuration for registering guides. For example, a system dedicated to registration of guides may be provided which is separate from the search system 130.

A prospective guide may elect to be a searcher and/or an ambassador, and/or to perform other activities. A prospective guide may undergo training and/or testing which may be used to determine whether a guide is competent to perform a task. After completion of testing and/or training, a guide may be allowed to perform a task. A registration and qualification process for a guide(s) is further described herein below. A guide may act as an ambassador, and/or as a searcher, etc. based on completion of training and/or testing. An ambassador processes a user search request and/or a search result(s). A searcher may receive a processed request and may perform a search responsive to the processed request. Various criteria may be considered for determining whether a guide may act as an ambassador and/or a searcher including but not limited to time spent as a guide, level of knowledge in particular area, etc. In at least one embodiment, the role of ambassador and searcher may be mutually exclusive.

The performance of an ambassador may be monitored. Multiple feedback mechanisms may be utilized including ratings by one or more users, guides, or other persons, time required to complete a task(s), complexity rating of a query, and/or other speed and/or quality metrics. In at least one embodiment, a rating of an ambassador may be based on a percentage of queries provided to an ambassador which are answered without utilizing a searcher.

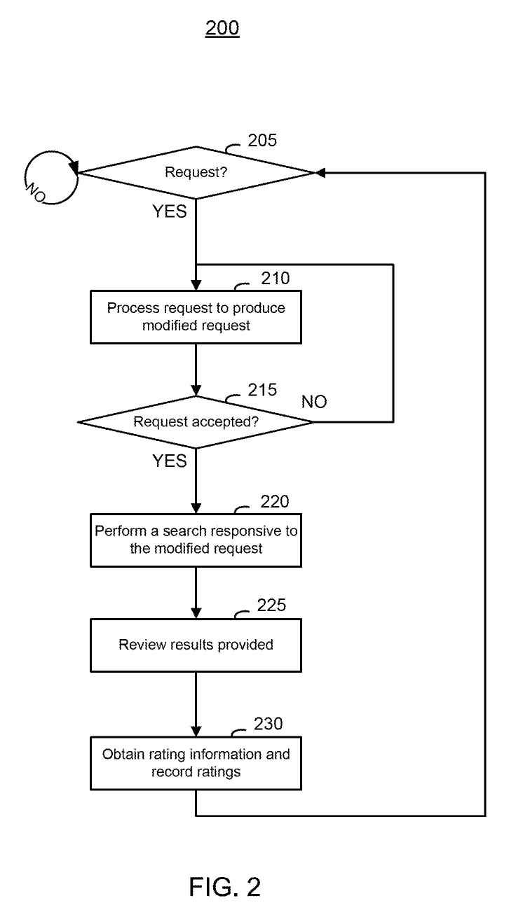

As illustrated in FIG. 2, a process 200 for performing an information search in which one or more ambassadors act as an intermediary is provided. The process 200 may be operative on any suitable elements of the system 100. In at least one embodiment, the process 200 is operative on a server associated with the search system 130.

In operation 205 (FIG. 2) a determination is made as to whether a request is received. If it is determined in operation 205 that a request is not received, control remains at operation 205 and process 200 continues. If it is determined in operation 205 that a request is received, control is passed to operation 210 and process 200 continues.

The determination in operation 205 may be made using various criteria. In at least one embodiment, if a message is received at a server associated with the search system 130, it may be determined that a request is received. For example, if an email message, an SMS, EMS, and/or MMS message, an IM, an IP message, and/or a voice message is received at an address associated with the search system 130 (FIG. 1) it may be determined that a request is received. The search system 130 may determine whether the assistance of a guide will be used to respond to a request as further described herein.

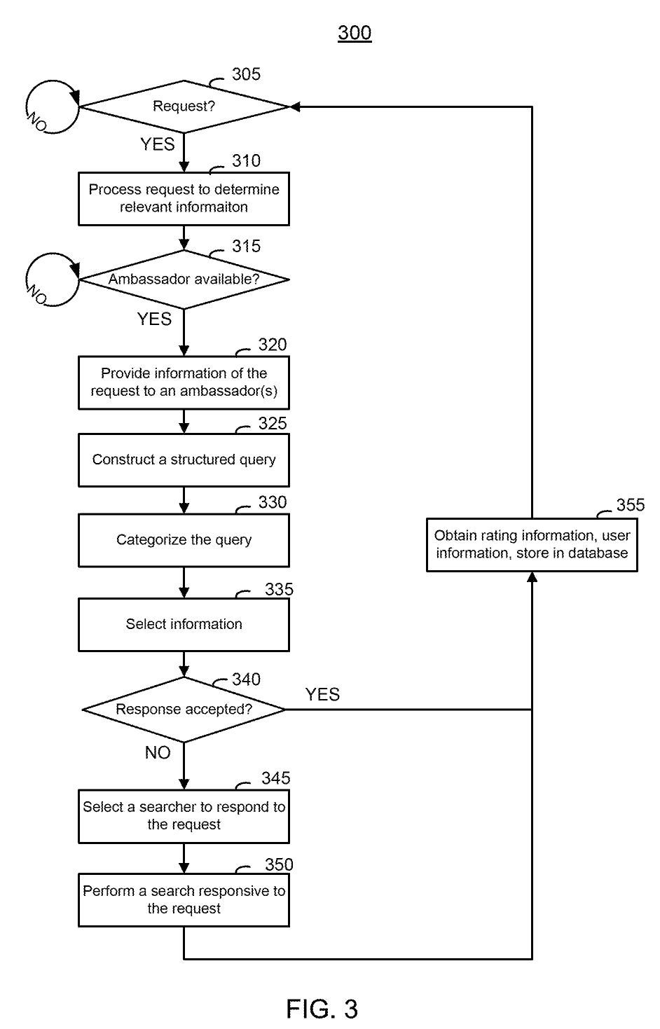

In operation 210 an ambassador processes a request. A process for augmenting, modifying or processing information of a request using an ambassador is further described herein with respect to FIG. 3. Control is passed to operation 215 and process 200 continues.

In operation 215 a determination is made as to whether a processed request is accepted. If in operation 215 it is determined that a processed request is not accepted, control is passed to operation 210 and process 200 continues. If in operation 215 it is determined that a processed request is accepted, control is passed to operation 220 and process 200 continues.

The determination in operation 215 may be based on various criteria. In at least one embodiment, a request modified by an ambassador may be automatically accepted if the ambassador indicates completion of a task. In at least one embodiment, a user may determine that a processed request is accepted. In at least one embodiment, a searcher may determine that a processed request is accepted. An ambassador may be associated with a rating and/or compensation structure. The rating and/or compensation of an ambassador may be affected by acceptance of a request processed by the ambassador. If a vetted query is not accepted by a searcher, it may be assigned to a second ambassador. Actions of guides may be utilized as a form of quality control. For example, if two ambassadors agree on the content of a vetted query, and a second searcher accepts a vetted query, the rejected vetted query may not be counted towards the rating and/or compensation of an ambassador. The compensation and/or rating of a searcher who rejected a vetted query may be affected if a rejected vetted query is accepted by an ambassador and/or a different searcher.

In operation 220 an information search is performed by a searcher responsive to a vetted query and a search result is returned. An information search may be performed by any guide. A searcher and/or an ambassador may perform a search. Control is passed to operation 225 and process 200 continues. Alternatively, in operation 220, an automated search without requiring a searcher may be performed responsive to the modified request.

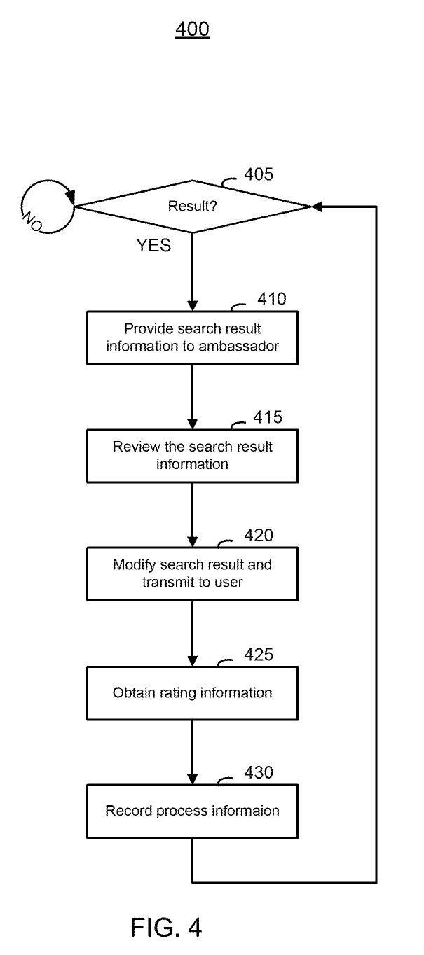

In operation 225 a search result is (optionally) reviewed by an ambassador and may be presented to a user. A process for review and presentation of a search result is further described herein below with respect to FIG. 4. In at least one embodiment, a search result may be sent to a user without requiring review by an ambassador. Control is passed to operation 230 and process 200 continues.

In operation 230 rating information is obtained. A rating may be based on user acceptance, and/or a review by a guide, and/or review by a system administrator. Information of the process 200 is recorded. Information such as ratings of a search result, ratings of a guide, ratings of a vetted query, time to perform operations, etc. may be recorded. For example, the database 120 (FIG. 1) may be updated to indicate actions of a user, a searcher, an expediter, processing of a query, etc. Control is passed to operation 205 and process 200 continues.

In at least one embodiment, an ambassador who performs the processing in operation 210 and an ambassador who performs the review in operation 225 may be the same person. In other embodiments, a different ambassador may perform the processing and the review operations. In at least one embodiment, a searcher may perform the review operation.

As illustrated in FIG. 3, a process 300 for providing a response to a request is provided. The process 300 may be operative on any suitable elements of the system 100. In at least one embodiment, the process 300 is operative on a server associated with the search system 130.

In operation 305 a determination is made as to whether a guided request is received. If it is determined in operation 305 that a guided request is not received, control remains at operation 305 and process 300 continues. If it is determined in operation 305 that a guided request is received, control is passed to operation 310 and process 300 continues.

The determination in operation 305 may be made based on various criteria. For example, a user preference may indicate that a guided search is to be performed. The search system 130 (FIG. 1) may determine whether a guided request is received. Content of a message may be used to determine whether a guide is to respond to a request. A target address such as a telephone number, a short code, an IM credential, etc. may be used to determine whether a guide is to respond to request. An automated analysis of a query may be performed as further described herein which may in part determine whether a guide will respond to a request.

In operation 310, a request (raw query, or original) is processed to determine relevant information. For example, a raw query may be processed to improve matching of the raw query to a database of queries. A raw query may include text, audio, and/or other media. A raw query may be processed in order to determine one or more keywords, categories and/or vetted queries which may be associated with a raw query. A vetted query is further described herein below. A user ID may be associated with a raw query, and a unique ID may be assigned to a raw query. A raw query may be compared to structured queries using stemming, word counts, and/or other forms of processing which are further described herein. Control is passed to operation 315 and process 300 continues.

In operation 315 a determination is made as to whether an ambassador is available to respond to a guided search request. If in operation 315 it is determined that an ambassador is not available to respond to a guided search request, control is passed to operation 315 and process 300 continues. If in operation 315 it is determined that an ambassador is available to respond to a guided search request, control is passed to operation 320 and process 300 continues.

The determination in operation 315 may be based on various criteria. In at least one embodiment, any available ambassadors are notified, and a first ambassador to respond is selected. If an ambassador is notified and does not respond, the ambassador may be recorded as unavailable. In at least one embodiment, an ambassador may be selected based on information associated with a raw query. For example, an ambassador may be selected based on a type of device a requester is utilizing to submit a request, and/or to receive a search result. An ambassador may be selected based on a competency, a training status, a keyword and/or category, geographic information, demographic information, personality information, interest area information, affiliate group information, a contractual relationship, a language skill, etc., which may be associated with a raw query and/or an ambassador. If an ambassador is currently responding to a request, the ambassador may not be available to process another request. If an ambassador is not logged-in the ambassador may not be available. Availability of an ambassador may be determined dynamically. For example, if no ambassador who meets a group of criteria is available, one or more criteria may be modified so that an ambassador who meets a different group of criteria is available. Alternately, a system may wait until an ambassador who meets a group of criteria is available. An ambassador may be notified of a request via various forms of communication such as IM, a voice message, a pop-up in a browser, an email message, an SMS, EMS or MMS, etc. which may be used to communicate with a system associated with the ambassador.

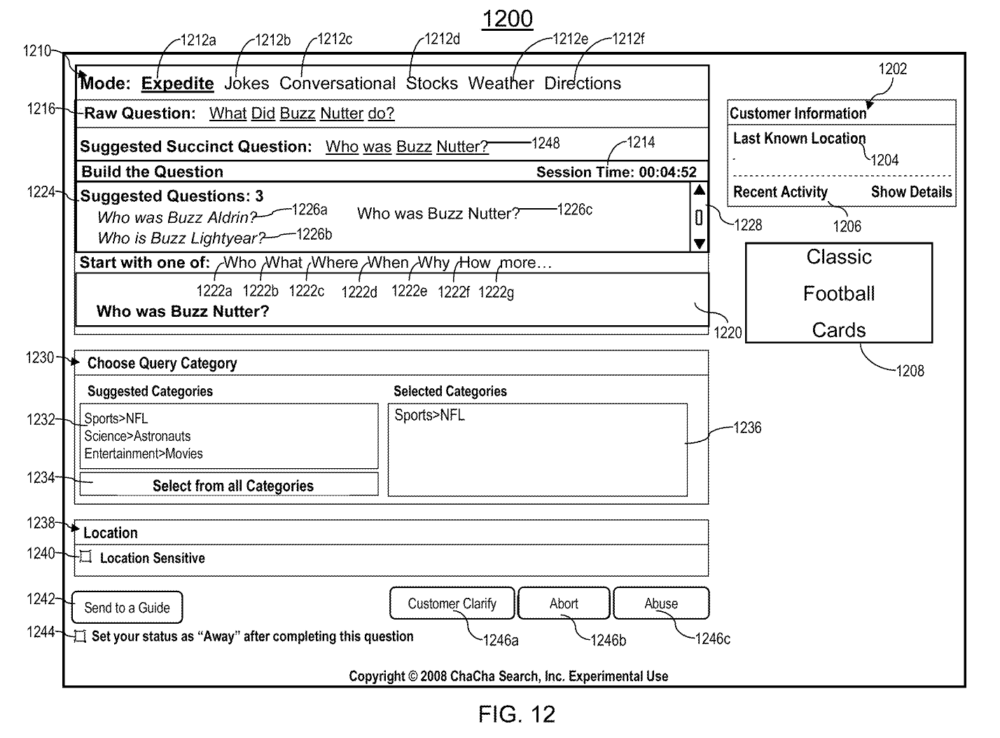

In operation 320 information of a raw query and/or associated information such as a keyword, category, profile, vetted query, etc. identified in operation 310 are provided to an ambassador. An ambassador may be presented with a GUI such as the GUI 1200 (FIG. 12) which may provide information of a request. Control is passed to operation 325 and process 300 continues.

In operation 325 an ambassador constructs a structured query. A structured query may be based on a keyword, category, image, audio, video, a profile, a structured query, a vetted query and/or any information associated with a raw query. An ambassador may select an advertisement which may be transmitted to a user. Control is passed to operation 330 and process 300 continues.

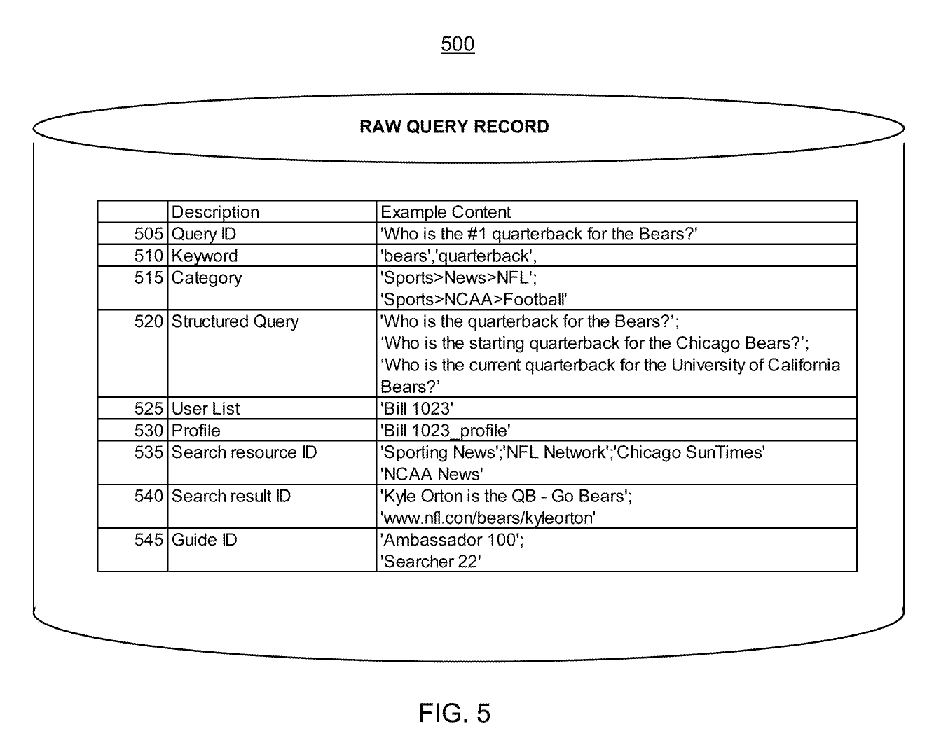

A vetted query be constructed by various construction methods. In at least one embodiment, a structured grammar is employed which includes phrasing a request in the form of a question. A structured query construction may require standard elements to be selected. Using the example illustrated in FIG. 5, the structured query ‘Who is the starting quarterback for the Chicago Bears’ is a structured query associated with the raw query ‘Who is the #1 quarterback for the Bears?’. An ambassador may communicate with a user using a real-time interface such as a chat or IM session, voice connection, text-to-speech, etc. Interaction with a user may allow an ambassador to determine information of a raw query including intended meaning of a keyword, a geographic location, and/or other information which may be used to form a structured query and/or which may be associated with and/or contained in a vetted query. An ambassador may confirm user acceptance of a structured query which is associated with a raw query. An ambassador may modify, adjust, qualify and/or supplement a keyword and/or other information of a raw query. For example, if the query ‘best apple’ is a raw query, an ambassador may construct the structured query ‘what is the best apple computer available?’, or the structured query ‘what is the best apple for baking a pie?’, or the structured query ‘what is the best apple?’ Although a vetted query may be ambiguous, it is structured to conform to a standard format, which may improve matching of raw queries to structured queries.

An ambassador may be presented with a query template which requires selection of a number of elements of a structured query from a list of available alternatives. In at least one embodiment, an interrogatory word or phrase such as ‘what, who, when, where, how many’, etc., may be selected from a list, and/or a verb or verb form such as ‘is, was, will be’, etc., may be selected from a list. A structured query may be analyzed automatically to check for conformance to spelling and grammatical conventions of a target language. A structured or vetted query may allow a searcher to receive a query which contains a standard set of information from an ambassador. A vetted query may format a request for submission to an automated search system. An ambassador may select elements of a structured query based on a keyword and/or category associated with a raw query. A raw query submitted by a user such as ‘bear's quarterback’, or ‘QB for the bears’ may for example be converted to a succinct or structured query such as ‘Who is the starting quarterback for the Chicago Bears?’. One or more previously constructed structured queries associated with a raw query may be presented to an ambassador as further described herein.

In operation 330 (FIG. 3) a request is associated with a number of categories. A categorization may be automatically associated with the raw query. An ambassador may be presented with a list of categorizations which may be associated with a request. In at least one embodiment, an ambassador is not allowed to change a categorization associated with a structured query. For example, a categorization of a query reviewed by a number of ambassadors and/or searchers may not be permitted to be changed by a particular ambassador. Alternately, an ambassador may be allowed to change a categorization associated with a structured query based on various criteria. An ambassador may be allowed to change a categorization of a structured or vetted query based on a ranking, rating and/or other characteristic associated with an ambassador and/or a structured query. For example, an ambassador who has correctly categorized a number or a percentage of succinct or structured queries may be allowed to modify a categorization associated with a structured query. If a structured query has not been categorized more than a number of times by an ambassador, an ambassador may be allowed to modify a categorization associated with the structured query. For example, if a structured query is associated with a category three times a change of categorization may not be allowed subsequently. A structured query which is brief such as ‘Who are the Bears?’ may be allowed to be associated with multiple categories. A structured or “succinct” query which is more specific such as ‘Who is the current quarterback for the University of California Bears?’ may be allowed to be associated with only one category. Selection or creation of a structured query may change the ranking of a category associated with a request.

An ambassador may be presented with a taxonomy tree structure which allows an ambassador to modify a categorization of a request. In at least one embodiment, a categorization selected by an ambassador may be used to determine a most likely categorization of a vetted query. Control is passed to operation 335 and process 300 continues.

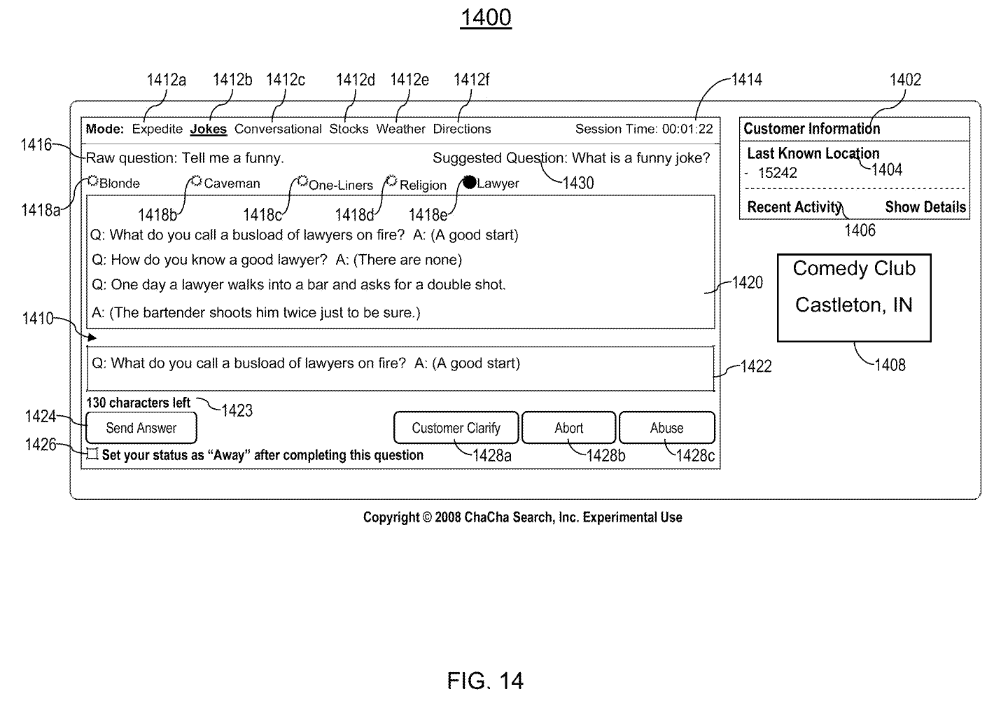

In operation 335 an ambassador selects information (a search result and/or other response) which may be presented to a user. For example, an ambassador may select an advertisement to be presented to a user. A selection may be based on an explicit selection by a guide, and/or may be based on a number of categories selected by a guide. A category association may be used to select a guide and/or information to be presented to a user and/or a guide such as an advertisement, a search resource, and/or a search result. In at least one embodiment, an ambassador may be presented with one or more search results which have been associated with a vetted query based on a ranking of a search result. A search result associated with a vetted query may be selected in various ways. A vetted query may be associated with a human-touched (reviewed) search result which has been judged superior to one or more algorithmic search results based on voting by one or more guides. A vetted query may be associated with a search result produced by an algorithmic search engine. A vetted query may be associated with a search result produced by an affiliate group. An ambassador may select a search resource which may be provided to a guide and/or a user. A search result may be automatically provided to a user based on the association of a search result with a vetted query. A search result may be selected by an ambassador. An ambassador may select to transmit any or all information associated with a vetted query to a user. An exemplary GUI 1400 for selection of a response is illustrated in FIG. 14. Control is passed to operation 340 and process 300 continues.

In operation 340 a determination is made as to whether a response is accepted. If in operation 340 it is determined that a response is accepted, control is passed to operation 355 and process 300 continues. If in operation 340 it is determined that a response is not accepted control is passed to operation 345 and process 300 continues. In at least one embodiment, acceptance of a response or result may be determined based on user actions such as activating an action button, clicking on a link associated with a result, and/or sending a text message. In at least one embodiment, if an ambassador selects a search result, it is determined that a response is accepted.

In operation 355 a rating of an ambassador is determined. A rating of an ambassador may be determined based on factors such as user acceptance of a search result provided, time required to send a search result to a user, a number of structured queries submitted to a user for review, click-through of an advertisement, a rating by a user a guide, a system administrator, etc. For example, if a user accepts a first vetted query proposed by an ambassador, an ambassador may receive a high rating, or if a user ‘clicks through’ a search result or advertisement provided by an ambassador, the ambassador may receive a high rating. In at least one embodiment, an ambassador rating may be based on acceptance of a vetted query by a searcher. In at least one embodiment, an ambassador rating may be based on the time between receiving a query and when a search result is accepted. In at least one embodiment, an ambassador rating may be based at least in part on a percentage of search queries which require a search by a guide other than the ambassador. A rating of an ambassador may be based on a combination of ratings from a number of search sessions, and/or rating factors. An ambassador rating may be based on any information indicated in the database 120 (FIG. 1). Information of the process 300 is recorded. Information of a structured query, a raw query, a vetted query, a category, a keyword, an ambassador, a searcher, a search result, an advertisement, and/or a user may be recorded and/or modified. Control is passed to operation 305 and process 300 continues.

In operation 345 a searcher is selected. An ambassador may select attributes of a searcher to provide a search result responsive to a query or request. An ambassador may be presented with information regarding searchers available to respond to a request. An ambassador may communicate with a user to modify criteria used to select a searcher. For example, an ambassador may determine time, rating, ranking, affiliation, demographic, geographic and/or other criteria for selection of a searcher. In at least one embodiment, an ambassador may determine whether an immediate response is required by a user in order to select a searcher. In at least one embodiment, an ambassador may select a searcher based on information such as a rating of search result which has been provided by a searcher. A searcher may be selected automatically. For example, a searcher may be selected by the search system 130 (FIG. 1). Control is passed to operation 350 and process 300 continues.

In operation 350 a search is performed by a searcher. A searcher may be a selected searcher. A rating(s) of an ambassador may be determined. A rating(s) of an ambassador may be based on various criteria as described herein above. For example, actions of a selected searcher may influence a rating of an ambassador that responded to a request. In at least one embodiment, a search result is provided by a searcher. Control is passed to operation 355 and process 300 continues.

As illustrated in FIG. 4, a process 400 for reviewing and/or modifying a search result is provided. The process 400 may be operative on any suitable elements of the system 100. In at least one embodiment, the process 400 is operative on a server associated with the search system 130. In at least one embodiment, a searcher may perform a review of a search result.

In operation 405 a determination is made as to whether a search result is received. If in operation 405 it is determined that a search result is not received control remains at operation 405 and process 400 continues. If in operation 405 it is determined that a search result is received control is passed to operation 410 and process 400 continues.

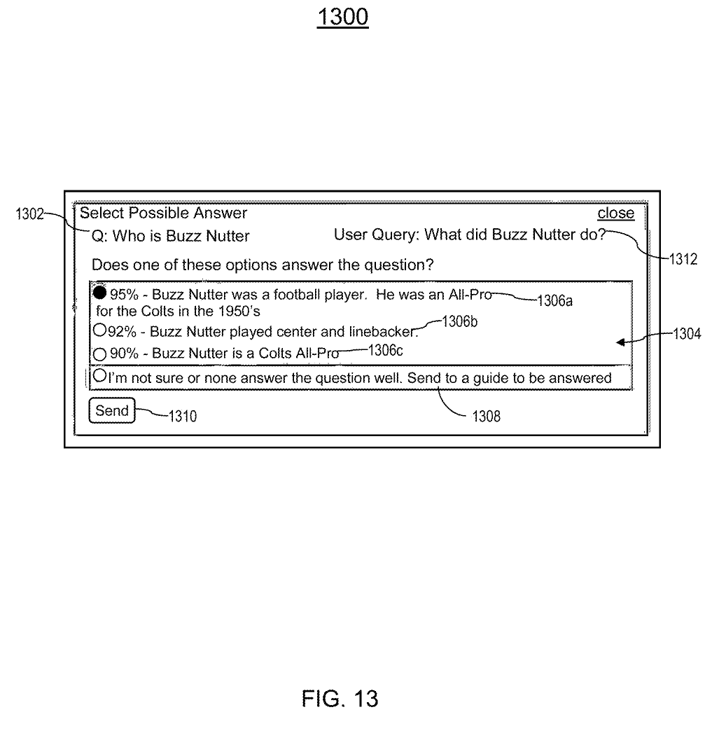

In operation 410 information of a search result is presented for review by an ambassador who may also be a guide and/or searcher. In one embodiment, the guide is a first available ambassador selected by the search system 130 (FIG. 1). In other embodiments, a guide may be selected based on criteria such as a rating, a skill set of a guide, a capability(ies) of a searcher system such as the ambassador system 145 (FIG. 1), or other information indicated in the database 120. Information of a search result may be presented to a guide using a GUI such as the GUI 1300 illustrated in FIG. 13. Control is passed to operation 415 and process 400 continues.

In operation 415 a guide reviews information of a search result. A review may be based on criteria such as relevance, credibility, completeness, reference type, media type, etc. Control is passed to operation 420 and process 400 continues.

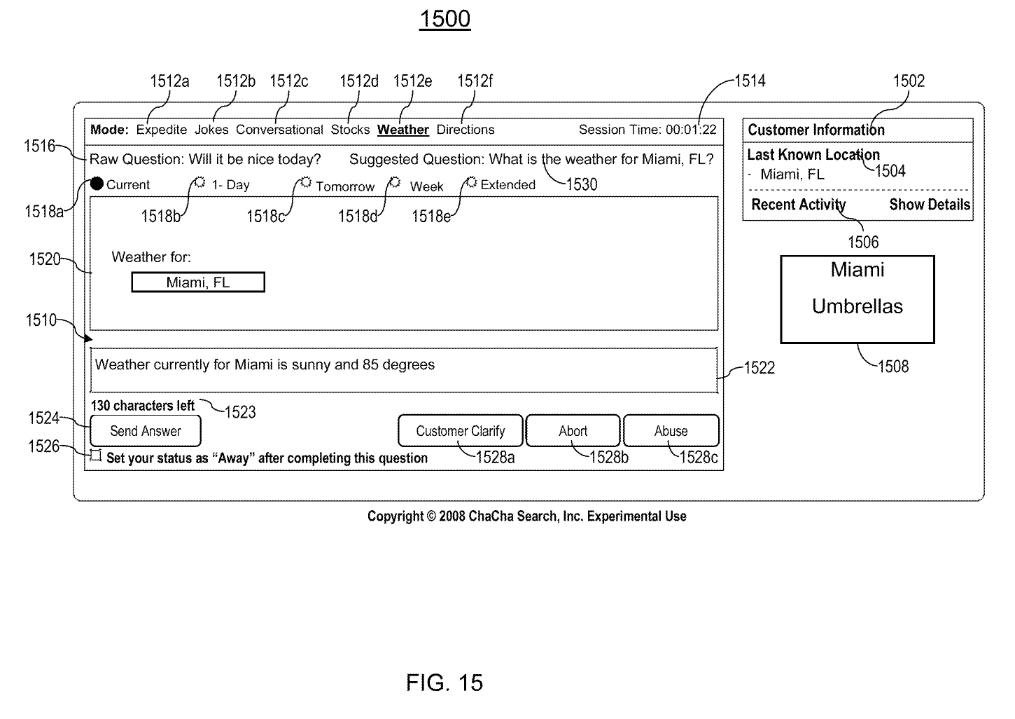

In operation 420 a search result is modified and transmitted to a user. Modification of a search result may be performed according to various criteria. In at least one embodiment, a search result is restructured to a standard search result format. An initial structured search result may be presented to an ambassador, based on an automated analysis of a search result. A search result may be modified for various reasons. For example, an ambassador may elect to send only one search result. This may for example be due to a constraint of a user system. For example, if a user is utilizing a messaging system such as SMS or other messaging services such as multimedia messaging service (MMS), a search result may be modified to be suitable for the capabilities of a user device. Likewise, if a user is utilizing a voice-based device, an ambassador may modify a search result to be suitable for voice communication such as VoIP, text-to-speech, or other voice based systems. An ambassador may send a search result to more than one user device. For example, an SMS result may be sent to a text-based user device, and a search result may be posted to a web page of the search system 130 (FIG. 1) which may be accessed by a user at a later time, or a voice reply may be transmitted, and a text reply may be sent. An ambassador may determine a format for replying to a user based on interaction with a user. An ambassador may select an advertisement to be sent to a user. An exemplary GUI 1500 for reviewing, modifying and transmitting a response to a user is illustrated in FIG. 15 Control is passed to operation 425 and process 400 continues.

In operation 425 a rating may be obtained. A user rating of a search result, an ambassador, and/or an overall rating may be obtained. A rating of an ambassador may be determined based on various factors such as time from receipt of a search result by an ambassador until a search result is sent to a user, number of search results sent to a user, number of search results accepted by a user, selection of an advertisement sent by an ambassador to a user, selection of a search result sent to a user by an ambassador, subsequent usage of the search system 130 by a user associated with an ambassador, number of search results requiring the use of a searcher other than the ambassador, etc. Control is passed to operation 430 and process 400 continues.

In operation 430, information of the process 400 is recorded. In at least one embodiment, process information is recorded in the database 120 (FIG. 1). Information associated with ratings provided by a user, a searcher and/or ambassador rating and/or ranking, delivery of a search result, actions of a user, a searcher, an ambassador, etc., may be recorded. Control is passed to operation 405 and process 400 continues.

When a request is received, content of the request may be recorded. Information associated with processing of a request may be recorded for various purposes. While specific examples of information which may be recorded are used for the purposes of illustration, other information may be recorded, and equivalent ways of storing and accessing which are well known in the art may be used to implement the systems and methods described herein.

As illustrated in FIG. 5, a sample of a raw query record, of which one or more may be associated with or resident in the database 120 (FIG. 1) is provided. The raw query record 500 may include a query ID field 505, a keyword field 510, a category field 515, a structured query field 520, a user list field 525, a profile field 530, a search resource ID field 535, a search result ID field 540, and a guide ID field 545.

A raw query record may be created by various processes including a guided search session, an interactive training session, a non-interactive training session. A raw query record may be imported from an external resource accessible to the search system, etc. In at least one embodiment, a raw query record is created if a request is received by the search system 130 (FIG. 1). A raw query (or original query) is a query which has not been processed. A raw query may include a fully-formed question/sentence, a keyword and/or a search phrase. A raw query may include media, including images, audio, video, etc., and may include information such as a phone number, an IM credential, and/or other data which is associated with a user system and/or communication service.

The raw query ID field 505 preferably contains a unique identifier of a raw query, which is preferably used consistently. For example, in at least one embodiment, the raw query ID field 505 can include a randomly generated numerical code, and/or a text string indicating the content of a raw query. A query ID serves to distinguish a raw query record associated with a raw query from a raw query record associated with other raw queries. Although particular examples of identifiers are described herein, other types of identifiers uniquely indicating a query may be utilized without departing from the spirit and scope of the embodiments herein.

A unique identifier is assigned to a raw query when it is entered into the database 120 (FIG. 1). If it is determined that a raw query is identical to an existing raw query in the search database, that query may be assigned the same query ID and may be added to the raw query record associated with the query ID. A request may include other information than that explicitly provided by a user. For example, location information, profile information, etc., may be associated with a query which might differentiate the query from a raw query in the database 120 (FIG. 1). A query may receive a new query ID and create an associated raw query record based on information indicated by a guide. In at least one embodiment, each request or raw query is assigned a unique ID. As illustrated in FIG. 5, the string ‘Who is the #1 quarterback for the Bears?’ is the query ID for the raw query record 500.

The raw query keyword field 510 may include information of a keyword associated with a raw query. Content of the raw query keyword field 510 may be created by an automated processing or parsing of a raw query. A human guide may select a keyword which is associated with a raw query. Processes for making and/or reviewing an association of a keyword with a raw query are further described herein. Using the example illustrated in FIG. 5 the keyword ‘bears’ and the keyword ‘quarterback’ are associated with the request ‘Who is the #1 quarterback for the Bears?’ Keywords associated with a request may be ranked, and may be presented to an ambassador in an order based on the ranking. Keywords associated with a request may be used to rank information associated with the request.

The raw query category field 515 may include information of a category associated with a raw query. Content of the raw query category field 515 may be created by an automated classification of a raw query. A human guide may select a category which is associated with a raw query. Processes for making and/or reviewing an association of a category with a raw query is further described herein. For example, in the record illustrated in FIG. 5, the categories ‘Sports>News>NFL’ and ‘Sports>NCAA>Football’ are associated with the raw query ‘Who is the #1 quarterback for the Bears?’ A category associated with a raw query may be used to rank information which may be selected responsive to the query. For example, if the category ‘Sports>News>NFL’ is associated with a query, guides(s) may be selected to respond to the query based on rankings associated with the category ‘Sports>News>NFL’.

The raw query structured query field 520 may include information of a structured query associated with a raw query. The raw query structured query field 520 may further include rating information of a structured query with respect to a raw query. A ranking or rating of a structured query may affect an order in which a structured query is presented to a guide when constructing a structured query. Using the example in FIG. 5, three structured queries have been associated with the raw query ‘Who is the #1 quarterback for the Bears?’ The structured query, ‘Who is the quarterback for the Bears?’, the structured query, ‘Who is the starting quarterback for the Chicago Bears?’ and the structured query, ‘Who is the current quarterback for the University of California Bears?’ are associated with the raw query ‘Who is the #1 quarterback for the Bears?’ A structured query may be rated in various ways. For example, a more specific structured query such as ‘Who is the current quarterback for the University of California Bears?’ may be rated higher than a less specific structured query such as ‘Who is the quarterback for the Bears?’ Alternately, a structured query may be rated based on frequency of use in a given time interval. For example, if the structured query ‘Who is the starting quarterback for the Chicago Bears?’ has been associated with the raw query ‘Who is the #1 quarterback for the Bears?’ by ambassadors sixty percent of the time in the last twenty-four hours, it might be ranked higher than another structured query which has been associated with the raw query ‘Who is the #1 quarterback for the Bears?’ by vetting guides twenty percent of the time in the last twenty-four hours. A structured query might be rated based on keywords associated with a raw query. For example, if a user has submitted multiple queries which have been associated with a keyword, a structured query associated with that keyword might be rated higher. A structured query may be rated based on a category associated with a raw query. A structured query may be rated based on a combination of ratings. A method for ranking of structured queries associated with a request is further described herein.

The raw query user list field 525 may include information of a user that submitted a raw query. The user list field 525 may be used to associate a user with a raw query. A raw query record may be created or modified when a user is associated with a raw query. Using the example illustrated in FIG. 5 the user ‘Bill1023’ is associated with the raw query ‘Who is the #1 quarterback for the Bears?’. Using the association of a user with a raw query, other information associated with a user may be presented to a guide.

The raw query profile field 530 may include information of a profile associated with a raw query. The raw query profile field 530 may be used to associate a profile, which may contain additional information such as geographic data, demographic data, personality data, time data, location based data, user system data, etc., with a raw query. A raw query record may be created or modified when a profile is associated with a raw query. Using the example illustrated in FIG. 5 the profile ‘Bill1023_profile’ has been associated with the raw query ‘Who is the #1 quarterback for the Bears?’ This may indicate that profile information associated with the user ‘Bill1023’ is associated with the raw query ‘who is the #1 quarterback for the Bears?’ A profile associated with a raw query may be used to modify processing of a query, to rank an item which is to be associated with a raw query or request, to target advertisements, etc.

The raw query search resource ID field 535 may include information of a search resource associated with a raw query. Information of a search resource associated with a raw query may be used to locate search resources which may be provided to a guide in order to obtain a search result responsive to a request. In at least one embodiment, a search resource is associated with a category. Using the example in FIG. 5, the resources ‘Sporting News’, ‘NFL Network’ and ‘Chicago SunTimes’ may be associated with ‘Sports>News>NFL’, and NCAA News' is associated with ‘Sports>NCAA>Football’. A resource may have a rating associated with a category, which may be used to rank a resource. A ranking of a resource associated with a category may affect a probability that a resource will be presented responsive to a request or raw query associated with the category.

The raw query search result ID field 540 may include information of a search result associated with a raw query. Information of a search result associated with a raw query may be used to provide a search result to a user. For example, the result ‘Kyle Orton is the QB-Go Bears’ might indicate a text message to be provided to a user via SMS, and the result <www.nfl.com/kyleorton> might be provided using a web serving functionality to a browser of a user device. Any number of search results may be associated with a request. A search result may be associated with a request automatically and/or using the assistance of a guide. In at least one embodiment, a ranking of a search result associated with a structured query may affect the probability that a search result will be associated with a request associated with the structured query.

The raw query guide ID field 545 may include information of a guide associated with a raw query. Information of a searcher associated with a raw query may be used to determine compensation for a guide. For example, a number of queries processed by an ambassador and/or a searcher may be used to determine compensation for the guide. Similarly, if a search result provided by a guide is reused, the guide may be compensated. Using the example in FIG. 5, the guides ‘Ambassador1000’ and ‘Searcher22’ are associated with ‘Who is the #1 quarterback for the Bears?’

A vetted query may be used to improve matching of a raw query. For example, a raw query may include errors, slang, anaphora, and/or other forms of natural language information which may be difficult to interpret using automated processing, but which may be readily understood by a person. An ambassador and/or a guide may select a vetted query which is associated with an answer in order to provide a response to a request. A vetted query may unambiguously map to a response, and/or may be used to assist a searcher to obtain a response.

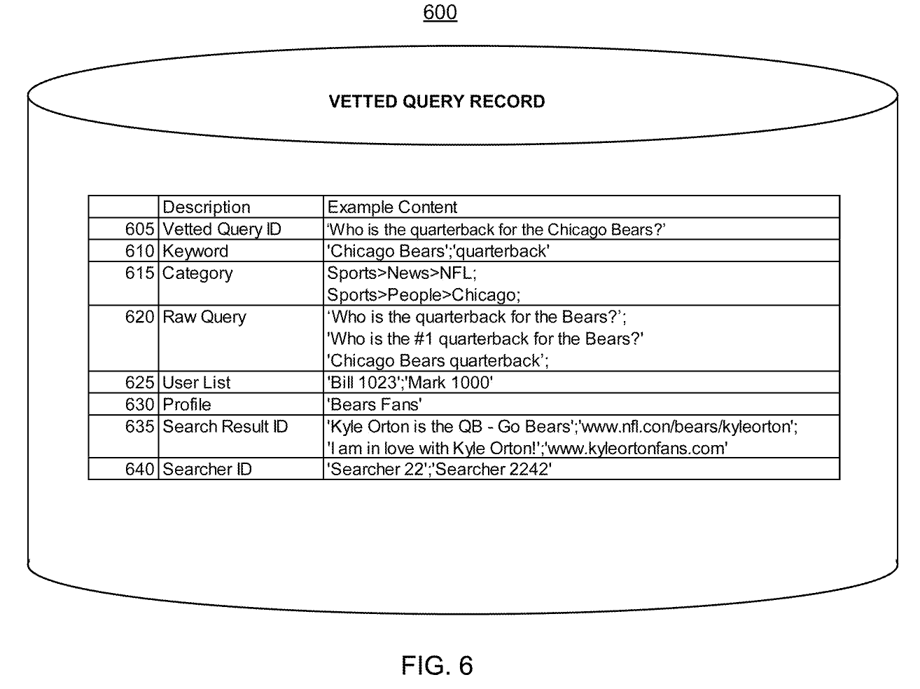

As illustrated in FIG. 6, a sample of a vetted query record 600, of which one or more may be associated with or resident in the database 120 (FIG. 1) is provided. The vetted query record 600 may include information of vetted query record including a vetted query ID field 605, a keyword field 610, a category field 615, a raw query field 620, a user list field 625, a profile field 630, a search result ID field 635, and a searcher ID field 640

A vetted query record may be created by various processes, including a guided search session, an interactive training session, a non-interactive training session. A vetted query record may be imported from an external resource accessible to the search system 130 (FIG. 1), etc. In at least one embodiment, a vetted query record is created by an ambassador. A vetted query may be associated with a number of search results. If a vetted query is selected, a search result and/or other information associated with the vetted query may be provided responsive to the selection. For example, if a vetted query is selected by an ambassador responsive to a request, a search result associated with the vetted query may be provided to a user and/or the ambassador.

The vetted query ID field 605 preferably contains a unique identifier of the vetted query, which is preferably used consistently. For example, in at least one embodiment, the vetted query ID field 605 can include a randomly generated numerical code, and/or a text string indicating the content of the vetted query. A vetted query ID serves to distinguish a vetted query record associated with a vetted query from a vetted query record associated with other vetted queries. Although particular examples of identifiers are described herein, other types of identifiers uniquely indicating a vetted query may be utilized without departing from the spirit and scope of the embodiments herein.

A unique identifier may be assigned to a vetted query when it is entered into the database 120 (FIG. 1). If it is determined that a vetted query is identical to an existing vetted query in the search database, that vetted query may be assigned the same vetted query ID and information may be added to the vetted query record associated with the vetted query ID. A vetted query may include other information than the explicit content of a request. For example, location information, profile information, etc. may be associated with a vetted query. For example, an identical structured query such as ‘Where is a good place for dinner?’ might be associated with multiple vetted queries depending on a profile (e.g. vegetarian, Muslim, Hindu) associated with the structured query. Information obtained by an ambassador may be used to differentiate one vetted query from another. As illustrated in FIG. 6, the string ‘Who is the quarterback for the Chicago Bears?’ is the query ID for the vetted query record 600 (FIG. 6).

The keyword field 610 for the vetted query may include information of a keyword associated with a vetted query. Content of the keyword field 610 may be created by an automated processing of a query. Keywords associated with a vetted query may be used to rank the vetted query. For example, if a raw query includes a keyword associated with a vetted query, the vetted query may be ranked higher and may be more likely to be provided to a user, an ambassador, a searcher, etc. For example, synonyms of nouns and/or noun phrases indicated in a vetted query might be indicated in the keyword field 610. Using the example in FIG. 6, the named entity ‘Chicago Bears’ and the noun ‘quarterback’ are associated with the vetted query record 600.

The category field 615 of the vetted query may include information of a category associated with a vetted query. If category associated with a vetted query is associated with a raw query, the vetted query may be ranked higher and may be more likely to be provided to a user, an ambassador, a searcher, etc. For example, if a category is associated with a raw query automatically, a ranking of a vetted query associated with the category might be used to determine an order in which the vetted query is presented to an ambassador. Using the example in FIG. 6, the categories ‘Sports>News>NFL’ and ‘Sports>People>Chicago’ are associated with the vetted query record 600.

The raw query field 620 of the vetted query may include information of a raw query which have been associated with a vetted query. It may further include rating information of a raw query with respect to a vetted query. The rating of a raw query associated with a vetted query may determine an order in which a vetted query may be presented to an ambassador when constructing a structured query responsive to a user request for information. For example, if a raw query has been associated with a vetted query by ambassadors fifty percent of the time, the vetted query may be presented higher in a list of suggested queries than a vetted query which has been associated with a raw query by ambassadors twenty percent of the time. A rating may be based on information such as ratings associated with a guide making an association of a raw query with a vetted query, voting by a guide associated with a category, keyword, profile and/or other information associated with a vetted query, etc. In at least one embodiment, a rating of a raw query associated with a vetted query may indicate a probability that a raw query is equivalent to the vetted query.

Using the example in FIG. 6, three raw queries have been associated with the vetted query ‘Who is the quarterback for the Chicago Bears?’ The raw query, ‘Who is the quarterback for the Bears?’, the raw query ‘Who is the #1 quarterback for the Bears?’ and the raw query, ‘Chicago Bears quarterback’ are associated with the vetted query ‘Who is the quarterback for the Chicago Bears?’ Such an association may be used to assist an ambassador in associating a raw query with a vetted query and/or to perform other tasks such as selecting an advertisement, a searcher, etc.

The user list field 625 for the vetted query may include information of a user that submitted a raw query which was associated with a vetted query to the search system 130 (FIG. 1). The user list field 625 (FIG. 6) may be used to associate a user with a vetted query. A vetted query record may be created and/or modified when a user is associated with a vetted query. Using the example illustrated in FIG. 6 the user ‘Bill1023’ may have submitted the raw query ‘Who is the #1 quarterback for the Bears?’ which is associated with the vetted query ‘Who is the quarterback for the Chicago Bears?’. As illustrated in FIG. 6, it is possible for more raw queries to be associated with a vetted query than users. For example, a phrase such as ‘Chicago Bears quarterback’ might be a phrase which was not submitted by a user, but which might be used to rank a vetted query versus a raw query.

Association of a user with a previous query may be used to associate a raw query submitted by a user with a vetted query. For example, a user who previously submitted the raw query ‘Who is the #1 quarterback for the Bears?’ which was associated with the vetted query ‘Who is the quarterback for the Chicago Bears?’ might submit a query such as ‘Who was the punter for the Bears in 1960?’. As the previous raw query was associated with the vetted query ‘Who is the quarterback for the Chicago Bears?’ the new raw query might be associated with the vetted query ‘Who was the punter for the Chicago Bears in 1960?’ Historical context information may be used automatically and/or may be presented to an ambassador and/or a searcher.

The profile field 630 of the vetted query may include information of a profile associated with a vetted query by the search system 130 (FIG. 1). The profile field 630 (FIG. 6) may be used to associate a profile which may include information such as geographic data, demographic data, personality data, time data, location based data, user system data, etc. with a vetted query. As previously mentioned, profile information may differentiate vetted queries which have similar query content. For example, if a raw query is associated with profile information, a ranking of a vetted query may be affected by a match between the profile information associated with the vetted query and the profile information associated with the raw query. A search result which is provided automatically when a vetted query is selected may be customized to a user profile. Profile information associated with a vetted query might also be used to determine information regarding a user. Using the example in FIG. 6, the profile ‘Bears Fans’ is associated with the vetted query ‘Who is the quarterback for the Chicago Bears?’ For example, the association of the users ‘Bill1023’ and ‘Mark1000’ with the vetted query record 600 may be used to infer that the users are ‘Bears Fans’ if multiple vetted queries associated with that profile are associated with the users. Likewise, a comparison of the profile ‘Bears Fans’ with profile information associated with ‘Bill1023’ and ‘Mark1000’ may affect a ranking of the vetted query ‘Who is the quarterback for the Chicago Bears?’ for a query submitted by ‘Bill1023’ and/or ‘Mark1000’

The search result ID field 635 for the vetted query may include information of a search result associated with a vetted query. Search results may be rated in association with a vetted query. For example, a number of guides and/or users may be presented with a query associated with the vetted query and one or more search results and may indicate an opinion regarding the search result. As illustrated in FIG. 6, the search results ‘Kyle Orton is the QB—Go Bears’, <www.nfl.com/kyleorton>, ‘I am in love with Kyle Orton!’ and <www.kyleortonfans.com>are associated with the vetted query ‘Who is the quarterback for the Chicago Bears?’ In at least one embodiment, a highest rated search result associated with a vetted query may be provided to a user if the vetted query is selected. In at least one embodiment, search results associated with a vetted query may be presented to a guide in an order which may be based on a ranking of the search results.

The searcher ID field 640 for the vetted query includes information of a guide associated with a vetted query. In at least one embodiment, a searcher is associated with a search result produced by the searcher. This may for example allow the search system 130 (FIG. 1) to track use of search result provided by a searcher. For example, a searcher might provide multiple responses to a vetted query in order that reuse of a search result associated with the searcher may be increased. Likewise, a searcher might provide different results which might be delivered to users using various communication services. For example, a searcher might provide a brief answer as an SMS message, a link to a URL for a web browser, a mixed media message for email delivery, etc. Likewise, an identifier of an ambassador who has utilized a vetted query might be indicated in the search result ID field 640. Using the example illustrated in FIG. 6, the searchers ‘Searcher22’ and ‘Searcher2242’ are associated with the vetted query record 600. This may indicate that ‘Searcher22’ and ‘Searcher'2242’ have provided a search result associated with the vetted query ‘Who is the quarterback for the Chicago Bears?’

In at least one embodiment, a raw query record such as the raw query record 500 may be used to track information of a query as it is processed by the search system 130 (FIG. 1). For example, when a request is received by the search system 130 a raw query record is created and the query ID field 505 and the raw query user list field 525 and the raw query profile field 530 are populated. A raw query may be processed automatically, and content of the raw query keyword field 510, the raw query category field 515, and the raw query structured query field 520 determined and rated. Automated categorization and keyword weighting may be performed. Matching to a database of structured queries may be performed using a full-text search facility such as Lucene which may perform stemming and fuzzy matching to determine a rating or probability that a raw query matches a structured query as further described herein.

Subsequently, if an ambassador selects a structured query to associate with a raw query, a search result may be associated with the raw query. Using the example in FIG. 6, if an ambassador elects to associate the vetted query ‘Who is the quarterback for the Chicago Bears?’ with the raw query ‘Who is the #1 quarterback for the Bears?’ that raw query is indicated in the raw query field 620 (FIG. 6). Search results associated with the vetted query record 600 may be associated with the raw query record 500, as indicated in the raw query search result ID field 540. An ambassador may select one or more of the search results associated with a vetted query to be provided to a user. In such an instance, the results selected may be indicated in the raw query search result ID field 540. As the searcher ‘Searcher 22’ is associated with the search results ‘Kyle Orton is the QB—Go Bears’ and <www.nfl.com/kyleorton>, as indicated in the vetted query searcher ID field 640 (FIG. 6), the ID of the searcher may be added to the Guide ID field 545 (FIG. 5). An identifier of an ambassador may be added to the raw query record 500 in order that ratings and/or compensation of an ambassador may be determined, as indicated in the raw query guide ID field 545. If no search result is associated with a vetted query, or if a rating of a search result associated with a vetted query is below a predetermined threshold, a query may be assigned to a searcher, as described further herein. A searcher may be provided with search resources associated with one or more categories selected by an ambassador.

A vetted query may allow the search system 130 (FIG. 1) to provide an automated response to a request. For example, if a vetted query is associated with a search result, if an ambassador selects and/or constructs a vetted query which is determined to match a vetted query in the database a highest ranking search result associated with the vetted query may be provided to a user.

A structured query may be used to obtain a dynamic search result automatically. For example, if a user asked ‘What did the Dow do today?’ an ambassador might provide the structured query ‘What is the closing price for the Dow Jones Industrial Average?’ which might produce a programmatic search result. Various forms of a natural language questions may be mapped by an ambassador to a vetted query, which may improve utilization of searchers and ambassadors.

By providing an ambassador guide, requests for which a response is readily available may be handled quickly and efficiently. Use of an ambassador and information included in a database of vetted queries may increase the number of automated responses, and/or may improve the targeting of a request to a searcher, the content and clarity of a request provided to a searcher and the selection of the search resources provided to a searcher. Information of activity of ambassador guides may be used to provide a database for processing of requests which may improve the performance of automated processing while providing human intervention efficiently.

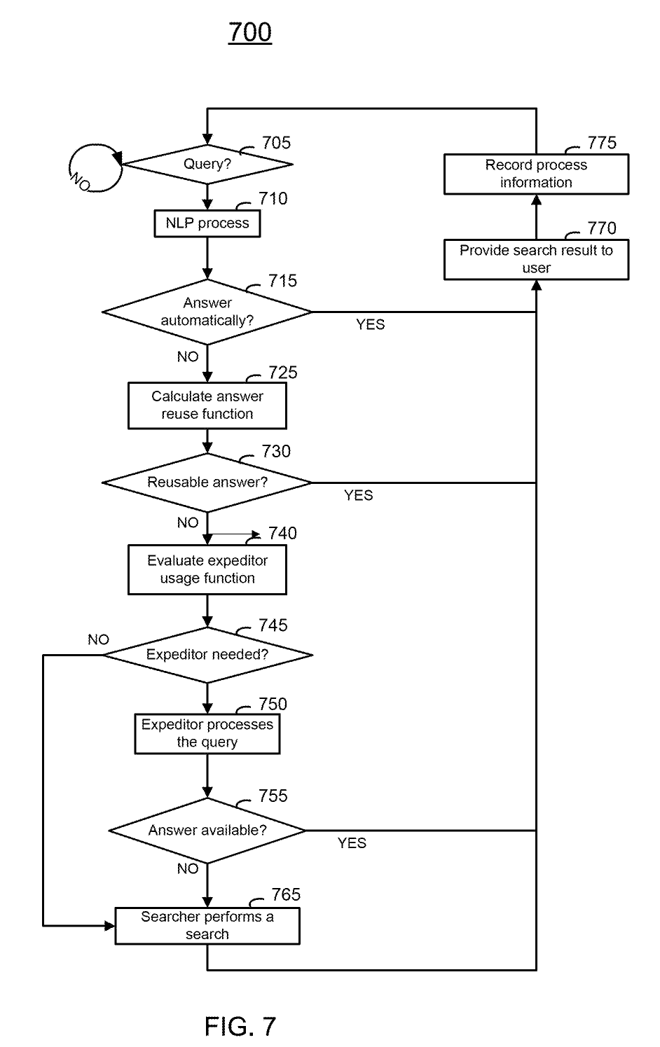

A process 700 for responding to a user request is illustrated in FIG. 7. The process 700 may be operative on any or all elements of the system 100 (FIG. 1). In at least one embodiment, the process 700 is operative on a server associated with the search system 130.

In operation 705 a determination is made as to whether a query (request) is received. If in operation 705 it is determined that a request is not received control remains at operation 705 and process 700 continues. If in operation 705 it is determined that a request is received control is passed to operation 710 and process 700 continues.

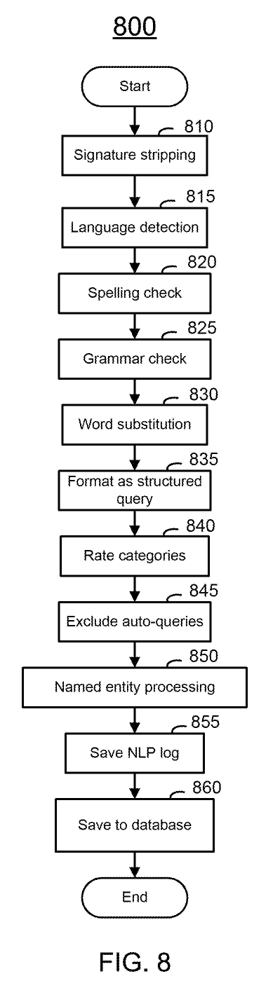

In operation 710 Natural Language Processing (NLP) is applied to a raw query. A raw query may have been converted from speech to text in order that NLP may be applied. An algorithm for NLP is further described with respect to FIG. 8 herein below. Control is passed to operation 715 and process 700 continues.

In operation 715 a determination is made as to whether a request may be answered automatically. If in operation 715 it is determined that a request may be answered automatically control is passed to operation 770 and process 700 continues. If in operation 715 it is determined that a request may not be answered automatically control is passed to operation 725 and process 700 continues. In at least one embodiment, it may be determined that a search result such as an advertisement, etc., may be provided automatically while a search result which might include an answer to a user query, a search resource, etc., might require further processing. In such an instance, control is passed to operation 770 and operation 725 simultaneously.

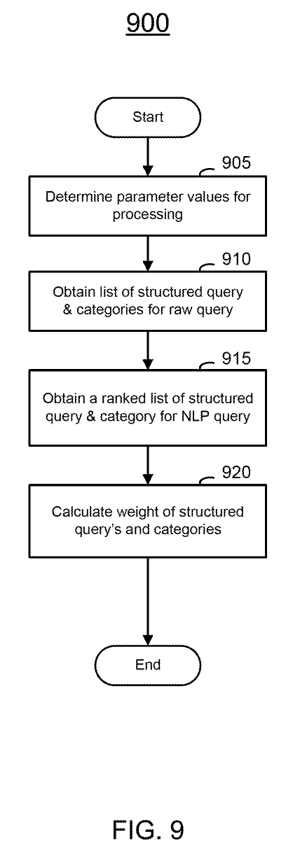

In operation 725 an answer reuse function is calculated. A process and functionality for determining a probability that a reusable answer responsive to a user request is available is further described herein with respect to FIG. 9. Control is passed to operation 730 and process 700 continues.

In operation 730 a determination is made as to whether a reusable answer is available. If in operation 730 it is determined that a reusable answer is available control is passed to operation 770 and process 700 continues. If in operation 730 it is determined that a reusable answer is not available control is passed to operation 740 and process 700 continues.

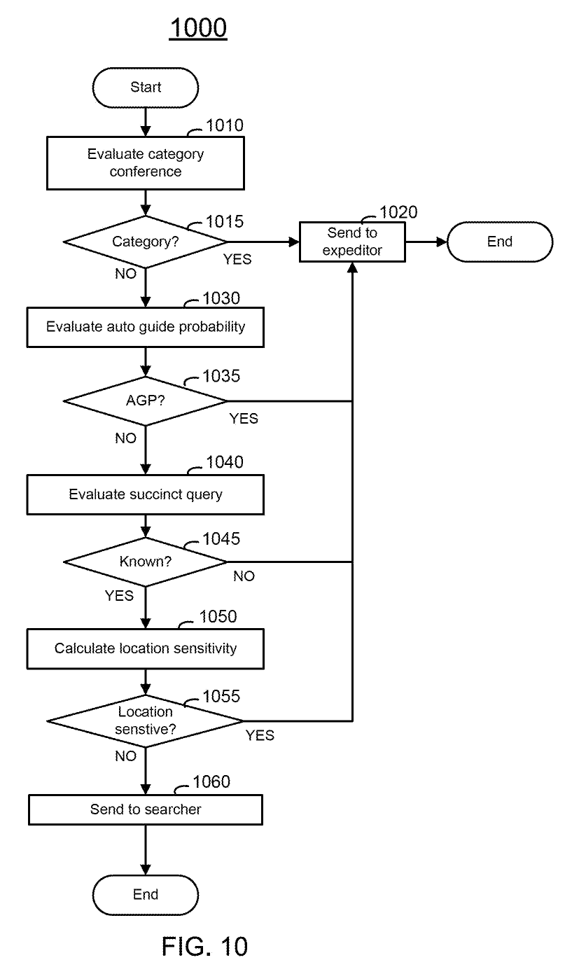

In operation 740 an expeditor usage function is calculated. A process and functionality for determining a probability that an expeditor is to be used is further described herein with respect to FIG. 10. Control is passed to operation 745 and process 700 continues.

In operation 745 a determination is made as to whether an expeditor is required to process a request. If in operation 745 it is determined that an expeditor is required to process a request control is passed to operation 750 and process 700 continues. If in operation 745 it is determined that an expeditor is not required to process a request control is passed to operation 765 and process 700 continues.

In operation 750 an expeditor processes a request. Processing of a request by an expeditor is further described herein. An expeditor may categorize a request, may form a structured query responsive to a request, may identify a type of automated processing which may respond to a request, may select an answer to a user request, may designate location, profile, and/or other information associated with a request, etc. Control is passed to operation 755 and process 700 continues.

In operation 755 a determination is made as to whether an answer is available to a user request. If in operation 755 it is determined that an answer is available to a user request control is passed to operation 770 and process 700 continues. If in operation 755 it is determined that an answer is not available to a user request control is passed to operation 765 and process 700 continues.

In operation 765 a searcher performs a search for information and provides a search result. A searcher may be selected based on any suitable criteria. In at least one embodiment, a highest ranking searcher associated with a category associated with a request is selected and is provided with search resources associated with information of the request such as a category, keyword, location, profile, etc. Control is passed to operation 770 and process 700 continues.

In operation 770 a search result is provided to a user. A search result may be provided to a user using any communication service associated with a user. A search result which has been provided by an automated resource, stored information, and/or by a human searcher is provided. Control is passed to operation 775 and process 700 continues.

In operation 775 information of the process 700 is recorded. For example, information of a user, a guide, a request, a resource, a keyword, a category, a vetted query, a profile, etc. which may have been modified by the process 700 may be recorded and/or updated. In at least one embodiment, process information is recorded in the database 120 (FIG. 1). Control is passed to operation 705 and process 700 continues.

As illustrated in FIG. 8 a process 800 for natural language based query formation and improvement is provided. The process 800 may be referred to as the Re-Writing Process (RWP). The process 800 may be operative on any or all elements of the system 100 (FIG. 1). In at least one embodiment, the process 800 is operative on a server associated with the search system 130 (FIG. 1).

In operation 810, a processing such as a signature stripping is performed. Some queries such as SMS, MMS, email, or IM based queries may include template information which must be removed in order to effectively determine user intent. For example, a user may have a signature message which is added to an email or SMS message. As this is easily detected by a person, if an expeditor identifies this content in a first message, subsequent messages may have the identified content removed without requiring the use of an expeditor. Likewise, standard email signatures which contain elements such as phone numbers, etc., might be detected and removed from a request message. In at least one embodiment, if calling number identification (CNID) information is available, a comparison of the trailing characters of a number of successive messages may be used to determine if a signature exists. For example if 3 or more successive messages include a common character string at the end of the message, it may be determined that the common characters represent a signature which is to be removed. Control is passed to operation 815 and process 800 continues.

In operation 815 language detection is performed. Various types of language detection algorithms may be applied. For example, a technique described in Language detection in unknown, International Conference on Computational Linguistics, Proceedings of the 18th conference on Computational linguistics—Volume 2 Saarbrücken, Germany SESSION: Project notes and demos Pages: 1021-1025, Year of Publication: 2000, relates to a typical algorithm, ora composite approach to language/encoding detection, S Li, K Momoi—Proc. 19th International Unicode Conference, 2001—sfr-fresh.com. A unique ID associated with a user, may be used to recognize an individual user, such an algorithm might be applied over a query history, and/or may be influenced by factors such as profile information, area code, etc. which may be associated with a user. Control is passed to operation 820 and process 800 continues.

In operation 820 a spelling check is performed. A query string may be ‘tokenized’ or separated into words based on white space indicators. Spelling check is performed using techniques such as word comparison and phrase comparison based on a language detected in operation 815. If language detection results were ambiguous, a spelling check versus more than one dictionary may be performed, and language detection may be repeated based on results of probable spelling corrections. A spelling check may include variances based on a type of device associated with a request. For example, a different correction algorithm might be applied for a query submitted using a 12-digit keypad, than a QWERTY keyboard. Control is passed to operation 825 and process 800 continues.

In operation 825 a grammar check is performed. Grammar check is performed using well known techniques such as an annotation graph, which are well known. For example ATLAS: A flexible and extensible architecture for linguistic annotation, Steven Bird, David Day, John Garofolo, John Henderson, Christophe Laprun, Mark Liberman, submitted on 13 Jul. 2000, describes a software tool for producing and using annotation graphs. An annotation graph such as a Penn Tree may be created wherein tokens are associated with parts of speech. Control is passed to operation 830 and process 800 continues.

In operation 830 a word substitution is performed. Word substitution is the process of replacing common abbreviations and/or slang forms of speech with an alternate form of a word or words. For example ‘b4’ might be replaced with ‘before’, or ‘u’ might be replaced with ‘you’, etc. Such a process may include factors which may be tailored to a user based on factors such as profile information (e.g. regional information, demographic, etc.) and/or query history information, etc. Control is passed to operation 835 and process 800 continues.

In operation 835 a query is formatted as a structured query. Such a process may be performed by semantic processing of a query. For example, a query may be created by converting a statement into a question. (e.g. ‘will it rain today?’ might be constructed as ‘what is the chance of rain today?’) Likewise, a raw query might be compared to a database of raw queries which have been associated with a succinct query by a guide(s). An annotation graph may be used to format a raw query. Control is passed to operation 840 and process 800 continues.

In operation 840 categories associated with a query are rated. An exemplary algorithm for selecting and rating a categorization associated with a query is The Ferrety algorithm for the KDD Cup 2005 problem Zsolt T. Kardkov and Domonkos Tikk and Zolt, SIGKDD Explorer Newsletter, volume 7, number 2, 2005, issn 1931-0145, pages 111-116, ACM, New York, N.Y., USA and <http://www.cse.lehigh.eduhbrian/pubs/2007/query-classification/LU-CSE-07-013.pdf> by Bhandari and Davison. A taxonomy for categorization may be used which is customized in order to index guides who may be associated with keywords, topics, and/or categories. Training of a classification algorithm based on query classification information provided by guides may be used to improve classification performance. A keyword of a query may be compared to keywords associated with an index of categories to determine a category which is associated with a query. For example, if a query includes a number of keywords which are associated with a category, the category may be more likely to be associated with the query. Likewise if queries associated with a category match a query, the category may be more likely to be associated with the query. Control is passed to operation 845 and process 800 continues.

In operation 845 automated and/or keyword based queries may be excluded from processing. For example, if a keyword is associated with a particular system response a query which begins with that keyword may be excluded from processing. This might include advertising keywords, and/or other words and/or phrases which are associated with an automated response. Likewise, a query which conforms to a query template after NLP may be selected for an automated response. For example, if a user submitted the query ‘wether 46038’, the corrected version ‘weather 46038’ would be automatically processed. Likewise a query such as ‘stok nfs’ which might be corrected to ‘stock nfs’ could be automatically processed. Control is passed to operation 850 and process 800 continues.

In operation 850 named entity processing is performed. Named entity processing techniques are well known in the art. For example Introduction to the CoNLL-2002 Shared Task: Language-Independent Named Entity Recognition, author Erik F. Tjong Kim Sang University of Antwerp, 2002 describes a typical process and method for performing named entity processing. For example, the search system 130 (FIG. 1) may access a database of named entities which may be included in the database 120, and/or may be an external search resource. Control is passed to operation 855 and process 800 continues.

In operation 855, information associated with the NLP operations performed in conjunction with the process 800 is recorded. For example, information of ratings of a category associated with a raw query, an annotation graph, named entity tags, etc associated with NLP processing of a raw query may be recorded in the database 120 (FIG. 1). For example, results of the processes, the confidence and/or probability factors associated with various versions of a query, etc., which may be shared with other processes and/or may be used to evaluate training and efficacy of a particular parametric tuning, etc. may be recorded. Control is passed to operation 860 and process 800 continues.

In operation 860, information associated with a query is updated. A query record such as the raw query record 500 may be updated to reflect categorizations, structured queries, keywords, and/or ratings information determined based on the process 800. Control is passed back to the parent process and process 800 terminates.

As previously discussed, answer reuse is important to success of a human-assisted search system as it directly impacts cost and economic viability of the system. In order that a previous search result or an automated search result may be provided responsive to a request, it is necessary to meet a combination of various conditions. For example, a request must be sufficiently similar to a request for which a search result is available. Likewise, an available search result must be of sufficient quality to be provided to a user. Criteria for matching and criteria for quality of a search result may change based on the nature of a request and a type of search result.

For example, a search resource, an advertisement, a game, an answer, contact information for a supplier of items or services, etc., may have different quality and/or matching criteria. Quality rating of a resource might be based for example on reliability of providing information. Quality rating of an advertisement might be based on fit with a category and/or a payment by an advertiser. Quality rating of a game might be based on a match to keyword and/or profile information associated with previous purchases.

Similarly to a quality rating, matching to a query may have different criteria for different types of search results. For example a search result such as an advertisement might be provided if matching is less exact, while a search result such as an answer to a question might be provided if matching is more exact. To determine whether an answer is to be reused, a function which describes a level of matching between a query and a reference query with which a search result is associated is needed. In at least one embodiment, software which implements an evaluation function is referred to as the “Answer Reuse Process” (ARP) and an ARP evaluation function is used to determine whether an answer is to be reused.

In at least one embodiment a process which provides a set of candidate queries which match a reference query and answers associated with the candidate queries is implemented. In at least one embodiment, the “Query Vetting Process” (QVP) compares any query to a database of queries and returns any queries which match the reference query to a given threshold. For example, the QVP might return all queries which matched any word in a query or any queries that match 80% of the words in a query, etc. Techniques such as stemming, etc. may be utilized by the QVP and a matching algorithm may be adjusted to provide a manageable set of queries and associated answers to the ARP. An index of queries may be used to determine matching of queries to a reference query. For example, queries may be considered to be documents within a corpus, and a ranking of a query with respect to a reference query may be determined based on word frequency analysis. Word frequency analysis may for example include a number of times a word appears in a reference query and a number of times the word appears in a query to be ranked. Word frequency analysis may include a weighting based on frequency of a word within a corpus. For example, words such as ‘the’, ‘of’, etc. which may appear in a high percentage of queries in a corpus of queries may have a low weighting, while words which appear with low frequency such as nouns, noun phrases, named entities, etc. may have a high weighting.

In at least one embodiment the ARP evaluator function which determines the probability that a search result will be reused is defined as

fₐᵣₚ(aₓ, q)=f_{qual}(aₓ)*f_{match}(q, qₐₓ) Eq. 1

Wherein:

fₐᵣₚ(aₓ,q) is the ARP answer rating for a potential answer (aₓ) with respect to the query (q). The answer rating function fₐᵣₚ is normalized such that it as a value between zero and one inclusive. In other words 0≦fₐᵣₚ(aₓ, q)≦1

f_{qual}(aₓ) is a quality rating associated with the answer aₓ with respect to the query, qₐₓ that is associated with the answer aₓ. The quality function f_{qual} is normalized such that it has a value between zero and one inclusive. In other words 0≦f_{qual}(aₓ)≦1

f_{match}(q,qₐₙₛ) is the Query Match Function, defined below, which rates the similarity between the reference query q and the query associated with the answer qₐₙₛ. The match function f_{match} is normalized such that it has a value between zero and one inclusive. In other words 0≦f_{match}(q,qₐₙₛ)≦1

An answer aₘₐₓ is selected which has the highest value of fₐᵣₚ for the set of answers which are associated with queries which are provided to the ARP by the QVP. If the value of fₐᵣₚ associated with the selected answer aₘₐₓ is below a threshold, the answer will not be reused. Thus the probability that an answer will be reused is a function of both the match between a query (e.g. a vetted query, a raw query, etc.) and the query associated with the answer and the quality rating associated with the answer and its related query.

The Answer Quality Function (AQF), f_{qual}(a), may be determined in various ways. For example, an answer which has been selected by a highly rated searcher may have a high value of f_{qual}(a). An answer which has received a high percentage of positive ratings by users and/or guides may have a high value of f_{qual}(a). An answer which has been provided by an automated search may have a low value of f_{qual}(a). In at least one embodiment, a discrete value function may be used to assign f_{qual}(a)=1 for a reviewed, superior, answer provided by a guide, f_{qual}(a)=0.7 for an answer which has received at least 80% positive ratings by users, and f_{qual}(a)=0.5 for an answer which has been selected by at least one ambassador. The AQF may include other variables such as how often a result has been provided to users, time based modification, sponsorship factors, adjustment for characteristics of a searcher, etc.

A Query Matching Function (QMF) is used to determine how closely related a test query is to a reference query. The QMF may be based on any information associated with a query such as a category, a structured query, a raw query, a profile, a location, a language, etc. A QMF acts to normalize a ranking of queries returned by a database query from an index such as that provided by the QVP. In at least one embodiment, the QMF is defined as:

$${f}_{match} ( q , {q}_{{a}_{x}} ) = {w}_{wb} {f}_{wb} ( q , {q}_{{a}_{x}} ) + {w}_{pb} {f}_{pb} ( q , {q}_{{a}_{x}} ) + {w}_{a c} {f}_{a c} ( {C}_{q} , {C}_{{q}_{{a}_{x}}} ) \qquad Eq . 2$$

The reference query, q, is the query which is to be matched from Eq. 1. In at least one embodiment, q is a succinct query which has been produced by the RWP process 800 (FIG.

8). The category set C^{q} is the set of categories that have been selected to be associated with the reference query q. In at least one embodiment, C^{q} is the set of categories which have been determined by the RWP process 800. The candidate answer aₓ is an answer which is associated with a set of vetted queries which has been selected for evaluation versus a reference query q. In at least one embodiment, the candidate queries and associated answers are provided by the QVP. The candidate category set

$${C}_{{q}_{{a}_{x}}}$$

the set of categories associated with the query associated with the candidate answer aₓ.

The QMF includes the weighting factors w_{wb}, w_{pb}, and w_{ac}. In order to preserve normalization it will be readily appreciated that the values of f_{wb}, f_{pb} and f_{ac} must be between zero and one inclusive, and that w_{wb}+w_{pb}+w_{ac}=1. The components of the match function f_{match} are the Wordbag Function (WBF), the Phrasebag Function (PBF) and the Autocat Function (ACF). The WBF is used to compare words and their grammatical functions between two queries. The PBF is used to compare phrases and their grammatical functions between two queries. The ACF is used to compare categories between two queries.

In at least one embodiment, the WBF compares the tagged word content of the reference query q and the query associated with the answer aₓ, qₐ using the following formula:

$${f}_{wb} ( q , {q}_{{a}_{x}} ) = \frac{\vert {Q}_{q} ⋂ {Q}_{{{q}_{a}}_{x}} \vert}{\vert {Q}_{q} ⋃ {Q}_{{q}_{{a}_{x}}} \vert} \qquad Eq . 3$$

Q_{q} is the set of tagged tokens in the reference query q. A “tagged token” is a word along with a tag which identifies the part of speech which has been determined from semantic analysis of context of the query. Tagged tokens are considered identical only if both the word content and the part of speech tag are identical.

$${Q}_{{q}_{{a}_{x}}}$$

is the set of tagged tokens in the query associated with the answer aₓ.

The Phrasebag Function (PBF) is similar to the Wordbag Function (WBF) but the PBF utilizes word phrases instead of words. W_{q} is the set of tagged phrases in the reference query q. A “tagged phrase” is a group of words along with a tag which identifies the part of speech associated with the group which has been determined from semantic analysis of context of the query (e.g. noun phrase, prepositional phrase, etc.). Tagged phrases are considered to be identical if both the phrase content and the associated tag are identical.

$${W}_{{q}_{{a}_{x}}}$$

is the set of tagged phrases in the query associated with the answer aₓ. The PBF is defined as:

$${f}_{pb} ( {q}_{{a}_{x}} , q ) = \frac{\vert {w}_{q} ⋂ {w}_{{q}_{{a}_{x}}} \vert}{\vert {w}_{q} ⋃ {w}_{{q}_{{a}_{x}}} \vert} \qquad Eq . 4$$

The WBF and the PBF may include consideration for synonyms and other word relations as well as the frequency of various tagged phrases. For example, a group of queries provided by the QVP might be indexed based on synonyms, and a WBF and PBF might be calculated based on the queries with the synonyms substituted. In such an instance a query such as ‘what is the most common bike?’ might cause the tokens ‘most common bicycle’, ‘most common motorcycle’ and ‘most common cycle’ to be used to retrieve candidate queries from an index. A WBF and PBF calculation might weight a match to the ‘most common bike’ a higher weight than a match to ‘most common bicycle’, etc. However, candidate queries which match the synonym tokens might be rated highly.

The Autocategorization Function (ACF) may be defined as:

$${f}_{ac} ( {C}_{{q}_{{a}_{x}}} , {C}_{q} ) = if \{ \begin{matrix}{C}_{q} ⋂ {C}_{{q}_{{a}_{x}}} = ∅ 0.0 \\ {C}_{q} ⋂ {C}_{{q}_{{a}_{x}}} \neq ∅ {f}_{smooth} ( max ( likelihood ( c ) ) ) , \\ c ∈ \{ {C}_{q} ⋂ {C}_{{q}_{{a}_{x}}} \}\end{matrix} \} \\ {f}_{smooth} ( x ) = \frac{sin ( x π ) + 1}{2} \qquad Eq . 5$$

That is to say, if the intersection of the set of categories associated with candidate queries returned by the QVP with the set of categories returned by the RWP is null, the value of the ACF is zero. If there are categories in the intersection, the highest rating value of any category in the intersection is selected. The rating value associated with the selected category is modified by the smoothing function fₛₘₒₒₜₕ. In embodiments, the WBF, PBF, and ACF may be ignored by setting the associated multiplier to zero. Weighting of the WBF, PBF, and ACF may be adjusted based on whether a person such as an expediter, a user, a searcher, etc., has reviewed a vetted query, category, rewritten query, etc.

Actions of guides and users responsive to results produced by NLP processing may be used to tune various elements of the performance of algorithms. For example, data of acceptance of a structured query by expeditors may be used to determine a weighting given to words and/or phrases when constructing a structured query. Similarly, language detection, named entity processing, spelling correction, etc., may be modified based on actions of guides. Feedback activities by guides may for example allow NLP, speech recognition, and/or other forms of automated conversion of requests to be personalized to a user without the need for a user to make such corrections.

As illustrated in FIG. 9 a process 900 for determining whether a reusable search result as a response to a request is available is provided. The process 900 may be operative on any or all elements of the system 100 (FIG. 1). In at least one embodiment, the process 900 is operative on a server associated with the search system 130 (FIG. 1).

In operation 905 parameters for the reuse evaluation function(s) such as those described herein above are determined. For example if the answer reuse function is to be evaluated (calculated) in operation 725 (FIG. 7) the parameters and/or the decision thresholds may be adjusted due to the lack of human intervention in the processing of the query. Likewise if a guide such as an expeditor, searcher, and/or transcriber has processed a query, parameters and thresholds for query matching and answer reuse and/or automation may be modified. Control is passed to operation 910 and process 900 continues.

In operation 910 a list (number) of structured or succinct queries which may be compared to a reference query and associated categories which are associated with a raw query are obtained. In at least one embodiment, the QVP may provide such information to the ARP. In at least one embodiment, candidate succinct queries may be selected based at least in part on content of search results or answers associated with the succinct queries. For example, an index such as a Lucene® index associated with a corpus of succinct queries may be queried and a number of the highest ranked queries associated with a raw query may be obtained. Control is passed to operation 915 and process 900 continues.

In operation 915 a ranked list (number) of structured or succinct queries and categories which are associated with a query produced by NLP operations such as those performed in the process 800 are obtained. In at least one embodiment, the QVP may provide such information to the ARP. Succinct queries may be selected based at least in part on content of search results associated with the succinct queries. Control is passed to operation 920 and process 900 continues.

In operation 920 the ARP evaluation function is evaluated for the set of answers associated with the structured queries and categories obtained in operation 910 and 915. In at least one embodiment, the queries from operation 910 are weighted differently than the queries from operation 915. In particular, if a structured query and a category have been determined by a guide and/or a user, answers and/or candidate queries associated with a raw query may be more or less likely to be selected. Information of the ARP evaluator function associated with the candidate answer set is recorded. For example, the ARP evaluator function value for answers associated with the three highest ranked or rated vetted queries may be recorded. Control is passed back to the parent process and process 900 terminates.

As illustrated in FIG. 10 a process 1000 for determining whether a request is to be directed to an expeditor or ambassador is provided. The process 1000 may be operative on any or all elements of the system 100 (FIG. 1). In at least one embodiment, the process 1000 is operative on a server associated with the search system 130 (FIG. 1).

In operation 1010 a function which measures a probability that a category selected to be associated with a request is valid is evaluated. A function such as the ACF described herein above may be utilized. A category confidence function may include factors such as user history, user profile, guides associated with a user, etc. In at least one embodiment the ACF is applied to a raw query and a succinct query created using the process 800 (FIG. 8). Control is passed to operation 1015 and process 1000 continues.

In operation 1015 a determination is made as to whether an expeditor is required to select a category to be associated with a request. If in operation 1015 it is determined that an expeditor is required to select a category to be associated with a request control is passed to operation 1020 and process 1000 continues. If in operation 1015 it is determined that an expeditor is not required to select a category to be associated with a request control is passed to operation 1030 and process 1000 continues. The determination in operation 1015 may be based on various criteria. For example, if the ACF value is below a predetermined value, it may be determined that an expediter is required to select a category associated with a request, or if an expeditor has previously categorized a query it may be determined that an expediter is not required to select a category.

In operation 1030 a function (the Auto Guide Probability (AGP) function) which measures a probability that a programmatic (automatic) response from a search resource may be used to respond to a request is evaluated. For example, a query may be analyzed to determine if it may be mapped to an API available to provide information such as weather, sports scores, etc. Likewise, keywords of a request may be examined in order to determine the probability that a response from an expeditor can be used. For example a function such as the ARF evaluation function may be applied to a query structure or template associated with a resource and a query. Items such as named entities detected in a query may be used to determine a probability that an expediter may respond to a request using an automated resource or ‘finder’ which utilizes stored information and/or responds to information provided using an API. The AGP function may be applied to the process step 715 (FIG. 7). Control is passed to operation 1035 and process 1000 continues.

In operation 1035 a determination is made as to whether an expeditor may provide a response to a request using a resource. If in operation 1035 it is determined that an expeditor may provide a response to a request using a resource control is passed to operation 1020 and process 1000 continues. If in operation 1035 it is determined that an expeditor may not provide a response to a request using a resource control is passed to operation 1040 and process 1000 continues. For example, a threshold value associated with a probability function such as the AGP may be compared to a computed value of the probability function for a request to determine whether an expediter may provide a response to a request using a resource. In at least one embodiment, a threshold used in operation 1035 may be lower than a threshold used in operation 715, which may be used to vary quality and/or cost of answering a query.

In operation 1040 a function which measures a matching range between a succinct query and a request is evaluated. For example, a function such as the WBF, PBF and/or ACF may be evaluated to determine if a candidate query, such as a query indicated in the database 120 (FIG. 1) matches a user request, which may include a succinct query. For example, a succinct query may exist which is not associated with an answer, and/or which is associated with an answer of low quality. Control is passed to operation 1045 and process 1000 continues.

In operation 1045 a determination is made as to whether a matching succinct query is known (available). If in operation 1045 it is determined that a matching succinct query is not available control is passed to operation 1020 and process 1000 continues. If in operation 1045 it is determined that a matching succinct query is available control is passed to operation 1050 and process 1000 continues. A threshold applied to the value of the function computed in operation 1040 may be used to determine whether a matching succinct query is available.

In operation 1050 a function which measures (calculates) the sensitivity of a request to location is evaluated. For example, if a user request includes a word which implies location (i.e. exophora) such as ‘here’, ‘there’, etc. and/or includes a named entity such as a street name, a city name, etc., a location sensitivity function may be affected by such content. For example, a query matching a user query may not be associated with an answer due to ambiguity which may be resolved based on location information. Likewise, a location sensitivity function may be affected by the presence and/or absence of location information associated with a user associated with a request. For example, if a query is associated with a reliable source of location information, and a query is for generic information, a value of a location sensitivity function may be reduced. Control is passed to operation 1055 and process 1000 continues.

In operation 1055 a determination is made as to whether a query is location sensitive. If in operation 1055 it is determined that a query is location sensitive control is passed to operation 1020 and process 1000 continues. If in operation 1045 it is determined that a query is not location sensitive control is passed to operation 1060 and process 1000 continues.

In operation 1060, information of a request is provided to a searcher. A searcher may be selected based on the categorization, succinct query, and/or other information including data associated with the request. It should be noted that the cost of processing a query may be reduced as a searcher may be responding to well formed queries in the searcher's area of interest, rather than responding to queries which may require revision, correction, etc. Control is passed back to the parent process and process 1000 terminates.

In operation 1020 information of a request is provided to an expeditor. A query has been evaluated to determine the nature of the request which may improve the probability that an expeditor may be selected more effectively. An expeditor may further be provided with a toolset which is adapted to the most likely response type for a query. As such an expeditor may be able to process a request more rapidly and with fewer errors. For example, if an expediter receives a request as a result of the determination in operation 1015, a categorization tool might be provided first, while if an expediter is provided with a query as a result of the determination in operation 1035, a tool for providing an answer using the most probable automated resource may be provided. Control is passed back to the parent process and process 1000 terminates.

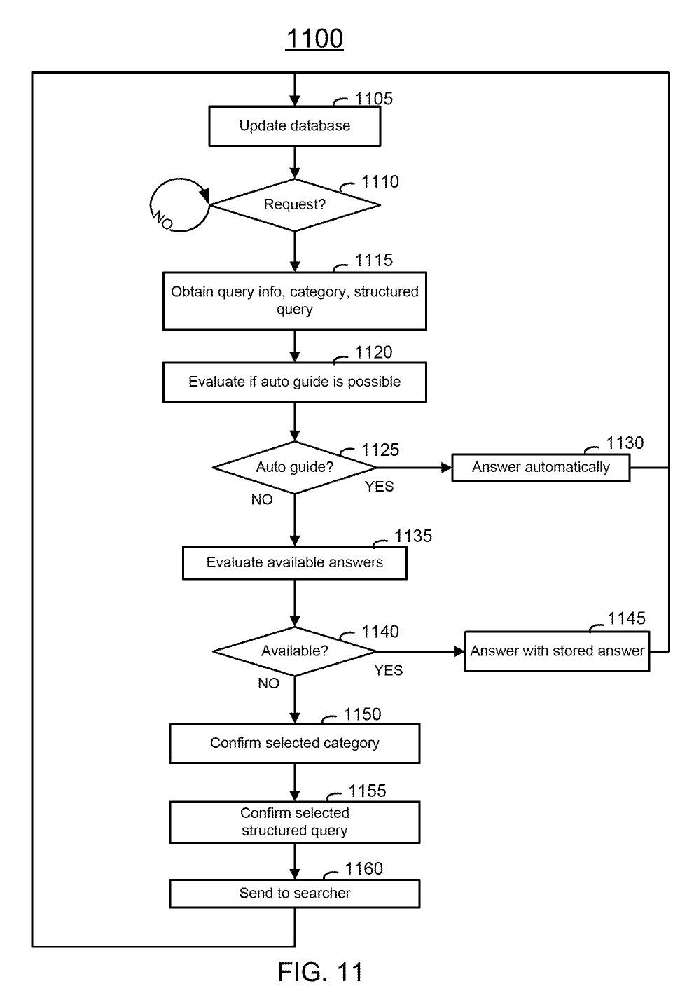

As illustrated in FIG. 11 a process 1100 for qualifying a query by an ambassador is provided. The process 1100 may be performed automatically, or may be performed using the assistance of a guide in any or all operations. The process 1100 may be operative on any or all elements of the system 100 (FIG. 1). In at least one embodiment, the process 1100 is operative on a server associated with the search system 130 (FIG. 1) and/or the ambassador system 145.

In operation 1110 a determination is made as to whether a request is received. If in operation 1110 it is determined that a request is not received control remains at operation 1110 and process 1100 continues. If in operation 1110 it is determined that a request is received control is passed to operation 1115 and process 1100 continues.

In operation 1115 information of a query including a category and a structured query is obtained. Any information associated with a query, such as a user history, a raw query, a processing history, etc., may be obtained. In at least one embodiment, information of a request is provided to an ambassador. Control is passed to operation 1120 and process 1100 continues.

In operation 1120, information of a query is analyzed for compatibility with available resource(s) which may provide a response. A function may be evaluated to determine if a query may be answered by an automated process. For example, if a query includes words, named entities, keywords, etc., such information may be evaluated. In at least one embodiment, information of a query is provided to an expeditor who may evaluate the ability to respond using a resource. An expediter may modify a query, which may be reevaluated automatically and/or when triggered by an expeditor. For example, the AGP function associated with a modified query may be evaluated. Control is passed to operation 1125 and process 1100 continues.

In operation 1125 a determination is made as to whether a resource may respond to a request (determine whether auto guide is applicable to the request received). If in operation 1125 it is determined that a resource may respond to a request, control is passed to operation 1130 and process 1100 continues. If in operation 1125 it is determined that a resource may not respond to a request, control is passed to operation 1135 and process 1100 continues. For example, if a guide has provided needed information for a resource to respond to a request, it may be determined that a resource may respond to a request.

In operation 1130 a response to a request is provided by a resource (an answer is provided automatically). For example, a database, news feed, RSS feed, a translation service, a music recognition service, and/or other system which may provide a response to a user request may provide information to a user. Multiple resources may be used to provide a response to a request. For example, a music lyrics feed and a translation service might be used to respond to the query ‘what is the first line of ‘Sesame Mucho’ in English?' In at least one embodiment rating information of a result provided may be obtained. Control is passed to operation 1105 and process 1100 continues.

In operation 1135, information of available answer(s) is evaluated with respect to information of a query including to determine suitability of an existing answer to be used to respond to a request. For example, a function such as the ARP function may be evaluated to determine if a query may be answered by a stored result. In at least one embodiment, information of a query is provided to an expeditor who may evaluate the ability to respond using an existing answer. An expeditor may modify a query, which may cause a matching function to be reevaluated automatically and/or when triggered by an expeditor. Control is passed to operation 1140 and process 1100 continues.

In operation 1140, a determination is made as to whether a stored answer may be used to respond to a request. If in operation 1140 it is determined that a stored answer may be used to respond to a request, control is passed to operation 1145 and process 1100 continues. If in operation 1140 it is determined that a stored answer may not be used to respond to a request, control is passed to operation 1150 and process 1100 continues. For example, if an expeditor selects an answer associated with a previous request, or if an expeditor indicates that an answer associated with a previous request is not suitable the probability that a stored answer may be used to respond to a user request may be increased or decreased.

In operation 1145 a stored response is provided. For example, an answer stored in the database 120 (FIG. 1) may be provided to a user. Rating information may be obtained based on actions of a user and/or a guide. For example if an expeditor has selected an answer to be provided to a user, a ranking and/or rating of the answer may be increased. Control is passed to operation 1105 and process 1100 continues.

In operation 1150, information of a category associated with a request is confirmed. In at least one embodiment, an ambassador may actively confirm a category associated with a request. In at least one embodiment, a category may be not be confirmed when an expeditor does not modify the category. Control is passed to operation 1155 and process 1100 continues.

In operation 1155 information of a succinct query associated with a request is confirmed. In at least one embodiment, an ambassador may be required to confirm a succinct query associated with a request. Control is passed to operation 1160 and process 1100 continues.

In operation 1160 a request and information associated with the request is provided to a searcher. For example, a succinct query, a category, user information, search resources, etc., which may be associated with a request may be provided to a searcher at a searcher system (e.g. the searcher system 105 (FIG. 1)) using a web server functionality of the search system 130 and a web browser functionality of a searcher system. Control is passed to operation 1105 and process 1100 continues.

In operation 1105 information associated with the query vetting process 1100 is recorded. For example the database 120 (FIG. 1) may be updated with information of a category, a succinct query, a response provided by a resource, a stored response provided, an ambassador, a guide, a query, etc., which have been modified by the process 1100 may be recorded. In at least one embodiment, usage information of a resource may be recorded to determine compensation for the resource. In at least one embodiment, use of a stored result may cause a rating of the stored result to be reduced. In at least one embodiment an amount of time required by an expeditor may be recorded in order to evaluate efficiency of the expeditor. Control is passed to operation 1110 and process 1100 continues.

An embodiment of tools for creation of a vetted query is illustrated in FIGS. 12 to 15. The embodiment may be used by an ambassador or expediter to process a request.

As illustrated in FIG. 12, the GUI 1200 includes a customer information window 1202, an advertisement window 1208, a query building window 1210, a category selection window 1230, a location selection window 1238, a ‘Send to Guide’ button 1242, a status selection tool 1244, and action controls 1246.

The customer information window 1202 may include a last known location indicator 1204 and a recent activity indicator 1206. The last known location indicator 1204 may display a user's most recent geographic location. This information may be used by the search system 130 and/or a guide to facilitate provision of an answer to a user that is relevant to a certain location, area, region, etc. The recent activity indicator 1206 may display a user's most recent requests and/or other context information which may be relevant to a request. For example, the recent activity indicator 1206 may display a user's previous queries, system responses, any advertisements that may have been provided to the user, previous search results, profile information of a user, etc. The advertisement window 1208 may display a selected advertisement based on content of the GUI 1200, which may be transmitted to a user based on actions of a guide. For example, one or more advertisements which have been selected based on content of a user query may be presented in an order determined by the search system 100 (FIG. 1). An expeditor may select an appropriate advertisement or other information based on information provided using the GUI 1200, which may be provided to a user as part of a clarification message, during a search by a guide, as an interstitial message, etc.

Prior to a providing a response to a query, an initial guide or ambassador may use the GUI 1200 to develop a well-formed or structured query from a user submitted query, categorize the query, provide a database response, ask a user for clarification, report abuse to the search system, etc., before passing the well-formed query on to an additional guide, if needed. The query building window 1210 may include query type controls 1212, a session time indicator 1214, a raw query indicator 1216, NLP processed query indicator 1248, a query building text box 1220, interrogative word selection controls 1222, a suggested questions window 1224, suggested question indicators 1226, and a scrolling control 1228.

The query building window 1210 may be used by a guide to develop a well-formed query based upon a user submitted query. For example, as illustrated in FIG. 12, the query ‘What did Buzz Nutter do?’ has been submitted. A guide may use the query type controls 1212 to select a GUI which may be used to provide a response to a user request. In at least one embodiment, the query type controls are provided as text links which may cause a GUI such as the GUI's 1400 (FIG. 14) and 1500 (FIG. 15) to be presented. If a raw query has been determined to match a classification of query with a pre-determined probability, a query processing GUI may be selected and presented first to an expeditor. In embodiments, the content of a GUI may be pre-filled with information based on a request. For example, if it has been determined that a query is most likely to be a request for financial information, a GUI associated with the ‘Stocks’ query type indicator might be provided first to an expediter.

Selection of an ‘Expedite’ query type control 1212a may cause the GUI 1200 to be provided. Selection of a ‘Jokes’ query type control 1212b to provide the GUI 1400 if the guide determines that a user request may be satisfied by a joke. Selection of a ‘Conversational’ query type control 1212c may result in a GUI for creating a conversational response being presented. Selection of a ‘Weather’ query type control 1212e may result in the GUI 1500 (FIG. 15) being presented. Likewise a GUI associated a ‘Stocks’ query type control 1212d, and a ‘Directions’ query type control 1212f may be selected by activating the respective query type controls. Any number of query type controls 1212 may be provided in the GUI 1200.The session time indicator 1214 may display an amount of time that is spent by a guide performing a task using the GUI 1200. Selection of the query type control may be indicated by underlining, and/or any suitable indicator such as color, shading, etc., as is well known in the art.

The raw query indicator 1216 may allow a guide to select any element of a query to include in a well-formed query that may be assembled in the query building text box 1220. For example, a guide may choose to select the named entity ‘Buzz Nutter’ using the raw query indicator 1216. The NLP processed query indicator 1248 may allow a guide to select any element of a succinct query which may have been produced by the search system 130 (FIG. 1) to include in a well-formed query that may be assembled in the query building text box 1220.

The interrogative word selection controls 1222 may include any number of interrogative words that a guide my select in assembling a well-formed query in the query building text box 1220. For example, if a query is submitted to the search system by a user in a declarative form, a guide may choose to start a well-formed query by activating the ‘Who’ word selection control 1222a, the ‘What’ word selection control 1222b, etc.

The query building window 1210 may include the suggested questions window 1224. The suggested questions window 1224 may include any number of suggested question indicators 1226 indicating queries which have been determined to match an NLP processed query and/or a raw query. Using the example in FIG. 12 the queries ‘Who was Buzz Aldrin?’, ‘Who was Buzz Nutter?’ and ‘Who is Buzz Lightyear?’ are presented in the suggested queries window 1224. The scrolling control 1228 may be used to view any additional suggested questions that may not be displayed. A guide may select a suggested question indicator 1226 by clicking or otherwise selecting the question. If a guide selects the suggested question indicator 1226c, the text of the associated question (i.e. ‘Who was Buzz Nutter’) is transferred to the query building text box 1220.

The category selection window 1230 may contain the suggested categories window 1232, the categories selection control 1234, and the selected categories window 1236. The suggested categories window 1232 may display any categories determined to be a potential category associated with the request. For example, as illustrated in FIG. 12, the categories, ‘Science>Astronauts’, ‘Sports>NFL’ and ‘Entertainment>Movies’ are displayed in the suggested categories window 1232 as a potential ‘match’ to the user submitted query, ‘What did Buzz Nutter do?’. A guide may use the categories selection control 1234 to select any category that may not be contained in the suggested categories window 1232. If a guide selects a category from the suggested categories window 1232, such selection may be indicated by the addition of the suggested category to the selected category window 1234 as shown by the selected categories ‘Sports>NFL’ in FIG. 12. In at least one embodiment, only one category may be associated with a query at a time.

The location selection window 1238 may include a location selection control 1240. If a guide determines that a user submitted query may be location related, a guide may select the location selection control 1240 in which case a subsequent guide may better provide an answer to a request. If the search system 130 (FIG. 1) determines that a user query may be location related the location selection control may be set to active by default.

The ‘Send to a Guide’ button 1242 may be selected if a guide has completed the assembly, formation, selection or otherwise of a well-formed query, and completed categorization of the query, or other operations as may be determined by the search system 130 (FIG. 1). A guide may select the ‘Send to Guide’ button to pass the vetted query to another guide, and/or to the search system 130 which may in turn provide an answer to a user request based on a vetted query. A guide may alternatively select from the user controls 1246. The ‘Customer Clarify’ user control 1246a may be selected to obtain clarification of a user submitted query and/or obtain additional information from a user that may be advantageous in forming a succinct query. The ‘Abort’ user control 1246b may be used to cancel the current session and close the GUI 1200. The ‘Abuse’ user control 1246c may be used to report abuse or other prohibited behavior of a user. The status selection tool 1244 may be used to indicate that a guide desires to change the status of the guide to ‘Away’ and not accept additional queries after completion of the current session.

A GUI for selecting an answer 1300 is illustrated in FIG. 13. The GUI 1300 may be provided as a ‘pop-up’ if a structured query from the suggested questions window 1220 (FIG. 12) is selected using the suggested question indicators 1226. Alternately, the GUI 1300 may be provided to a guide if it is determined that a structured query matches a user query, but the probability of a match is below a pre-determined threshold. For example, the search system 130 (FIG. 1) may determine that human judgment is required to confirm that a succinct query indeed matches a user request. Alternately, if a succinct query has been selected, and several answers with similar quality ratings are associated with the succinct query, an expeditor may select an answer. Such information may be used to modify a rating of the answers associated with the succinct query. In at least one embodiment, if an expeditor has selected the ‘send to a guide’ control 1242 and the vetted query is a match to a query indicated in a database, the GUI 1300 may be provided.

The GUI 1300 includes a user query indicator 1302, a succinct query indicator 1312, an answer selection window 1304, answer selection controls 1306, an answer rejection control 1308, and a completion control 1310.

The user query indicator 1302 provides information of a user query. The succinct query indicator 1312 provides information of a succinct query associated with a user request. The answer selection controls 1306 may be used to select an answer to be provided responsive to a user request. The answer selection control 1306a selects the answer ‘Buzz Nutter was a football player. He was an All-Pro for the Colts in the 1950's.’ The answer selection control 1306b selects the answer ‘Buzz Nutter played center and linebacker.’ The answer selection control 1306c selects the answer ‘Buzz Nutter is a Colts All-Pro.’ The answer selection controls 1306 may be mutually exclusive radio buttons, or other controls well known in the art. The answer rejection control 1308 may be used to indicate that a guide is unsure if the answers are relevant, if none of the answers are suitable, that a vetted query may be incorrect, or that a query should be sent to a guide for any reason. The completion control 1310 may be used to indicate completion of the selections in the GUI 1300.

As illustrated in FIG. 14, the GUI 1400 includes a customer information window 1402, an advertisement window 1408, an answer building window 1410, query type controls 1412, a session time indicator 1414, a user query indicator 1416, a suggested query indicator 1430, response type selection tools 1418, a provided answer display window 1420, an answer building text box 1422, a ‘Send Answer’ button 1424, a status selection tool 1426, and user controls 1428.

The customer information window 1402 may include the last known location indicator 1404 and the recent activity indicator 1406. The last known location indicator 1404 may display a user's most recent geographic location. This information may be used by the search system 130 (FIG. 1) and/or a guide to facilitate provision of an answer that is relevant to a certain location, area, region, etc. The recent activity indicator 1406 may display a user's most recent use of the search system 130 (FIG. 1) and/or other context information which may be relevant to a request. For example, the recent activity indicator 1406 may display a user's previous queries, responses by the search system 130 (FIG. 1), any advertisements that may have been provided to the user, previous search results, profile information of a user, etc. The advertisement window 1408 may display a selected advertisement based on content of the GUI 1400, which may be transmitted to a user based on actions of a guide. For example, one or more advertisements which have been selected based on content of a user query may be presented. An expeditor may select an appropriate advertisement and/or other information based on information provided using the GUI 1400, which may be provided to a user as part of a clarification message, during a search by a guide, as an interstitial message, etc.

A guide may select the ‘Jokes’ query type control 1412b to provide the GUI 1400 if the guide determines that a user request may be satisfied by a joke. Selection of the ‘Conversational’ query type control 1412c may cause a ‘Conversational’ GUI to be provided. Selection of the ‘Weather’ query type control 1412e may result in the GUI 4600 (FIG. 46) being presented. Likewise a GUI associated with ‘Stocks’ 1412d, and ‘Directions’ 1412f may be selected. Any number of query type controls 1412 may be provided in the GUI 1400. In at least one embodiment a first GUI provided to an expeditor may be determined based on analysis of a query.

The answer building window 1410 may include the user query indicator 1416, and the suggested query indicator 1430. The joke type selection tools 1418 may be selected by a guide based on a guide's interpretation of a query in the user query indicator 1416, and/or the suggested query indicator 1430. For example, as illustrated in FIG. 14, the user submitted query, ‘tell me a funny’ may be interpreted by automated processing of a request to be a request for a joke as indicated by the suggested query ‘What is a funny joke?’ In such a case, the GUI 1400 may be provided initially to an expeditor instead of the GUI 1200. A guide may select a category of response using the joke type selection tools 1418. For example, the joke category ‘Lawyer’ has been selected as indicated by the response type selection control 1418e. Alternatively, a guide might select ‘Blonde’ jokes 1418a, ‘Caveman’ 1418b, ‘One liners’ 1418c and ‘Religion’ 1418d. Any number of joke type selection tools 1418 may be provided.

If a guide selects any of the joke selection tools 1418, responses associated with the selected category in for example the search system database 120 (FIG. 1) may be displayed in the provided answer display window 1420. A guide may select any response displayed in the provided answer display window 1420 to submit as a response to a query. Alternatively, a guide may use any part of a provided answer and/or the guide's text as a response to a user submitted query by entering such text into the answer building text box 1422. In at least one embodiment, a guide may not be allowed to enter free form text in the answer building text box 1422. The text remaining indicator 1423 may display the number of characters a guide has remaining to provide an answer in the answer building text box 1422 based on a total number of characters and/or words that a guide is allowed to use in building an answer. The number of characters may be based on a user device constraint, or any system constraints.

The ‘Send Answer’ button 1424 may be selected if a guide has completed the assembly, formation, selection or otherwise an answer in response to a query. A guide may alternatively select from the user controls 1428. The ‘Customer Clarify’ user control 1428a may be selected to obtain clarification of a user submitted query and/or obtain additional information from a user that may be advantageous in forming an answer. The ‘Abort’ user control 1428b may be used to cancel the current session and close the GUI 1400. The ‘Abuse’ user control 1428c may be used to report abuse or other prohibited behavior of a user. The status selection tool 1426 may be used to indicate that a guide desires to change the status of the guide to ‘Away’ and not accept additional queries after completion of the current session.14

As illustrated in FIG. 15, the GUI 1500 includes a customer information window 1502, an advertisement window 1508, an answer building window 1510, query type controls 1512, a session time indicator 1514, a user submitted query indicator 1516, a suggested query indicator 1530, response type selection tools 1518, a provided answer display window 1520, an answer building text box 1522, a ‘Send Answer’ button 1524, a status selection tool 1526, and user controls 1528.

The customer information window 1502 may include the last known location indicator 1504 and the recent activity indicator 1506. The last known location indicator 1504 may display a user's most recent geographic location. This information may be used by the search system and/or a guide to facilitate provision of a query answer to a user that is relevant to a certain location, area, region, etc. The recent activity indicator 1506 may display a user's most recent use of the search system 130 (FIG. 1) and/or other context information which may be relevant to a request. For example, the recent activity indicator 1506 may display a user's previous queries, responses by the search system, any advertisements that may have been provided to the user, previous search results, profile information of a user, etc. The advertisement window 1508 may display a selected advertisement based on content of the GUI 1500, which may be transmitted to a user based on actions of a guide. For example, one or more advertisements which have been selected based on content of a user query may be presented in an order determined by the search system 130 (FIG. 1). An expeditor may select an appropriate advertisement and/or other information based on information provided using the GUI 1500, which may be provided to a user as part of a clarification message, during a search by a guide, as an interstitial message, etc.

A guide may select the ‘Jokes’ query type control 1512b to provide the GUI 1400 if the guide determines that a user request may be satisfied by a joke. Selection of a ‘Conversational’ query type control 1512c may result in a GUI for creating a conversational response being presented 15. Selection of the ‘Weather’ query type control 1512e may result in the GUI 1500 (FIG. 15) being presented. Likewise a GUI associated with ‘Stocks’ 1512d, and ‘Directions’ 1512f may be selected. Any number of query type controls 1512 may be provided in the GUI 1500. In at least one embodiment a first GUI provided to an expeditor may be determined based on analysis of the user query.

The answer building window 1510 displays the user query indicator 1516, and the suggested query 1530. The weather type selection tools 1518 may be selected by a guide based on a guide's interpretation of a query in the user query indicator 1516, and/or the suggested query indicator 1530. For example, as illustrated in FIG. 15, the user submitted query, ‘will it be nice today?’ may be interpreted to be a request for a weather information as indicated by the suggested query ‘What is weather for Miami, Fla.?’, which is at least in part determined by the location information indicated in the customer information window 1502. In such a case, the GUI 1500 may be provided to an expeditor first instead of the GUI 1200 (FIG. 12). A guide may select a category of response using the weather type selection tools 1518. For example, the weather category ‘Current’ has been selected as indicated by the weather type selection control 1518a. Alternatively, a guide might select the ‘1-Day’ 1518b, ‘Tomorrow’ 1518c, ‘Week’ 1518d and ‘Extended’ 1518e weather type selection tools. Any number of weather type selection tools 1518 may be provided.

If a guide selects any of the weather type selection tools 1518, responses associated with the selected type may be displayed in the provided answer display window 1520. A guide may select any response displayed in the provided answer display window 1520 to submit as a response to a query. Alternatively, a guide may use any part of a provided answer and/or the guide's text as a response to a user submitted query by entering such text into the answer building text box 1522. In at least one embodiment, a guide may not be allowed to enter free form text in the answer building text box 1522. The text remaining indicator 1523 may display the number of characters a guide has remaining to provide in the answer building text box 1522 based on a total number of characters and/or words that a guide is allowed to use in building an answer. The number of characters may be based on a user device constraint, or any system constraints. In the case of a request which may be processed using an automated resource, an answer may be provided without requiring selections by a guide in order to optimize the time required to respond.

The ‘Send Answer’ button 1524 may be selected if a guide has completed the assembly, formation, selection or otherwise an answer in response to the user submitted query. A guide may alternatively select from the user controls 1528. The ‘Customer Clarify’ user control 1528a may be selected to obtain clarification of a user submitted query and/or obtain additional information from a user that may be advantageous in forming an answer. The ‘Abort’ user control 1528b may be used to cancel the current session and close the GUI 1500. The ‘Abuse’ user control 1528c may be used to report abuse or other prohibited behavior of a user. The status selection tool 1526 may be used to indicate that a guide desires to change the status of the guide to ‘Away’ and not accept additional queries after completion of the current session.

Efficient utilization of human assistants or guides in a human assisted search system is an important element of success. Better utilization of the expeditor and searcher is desirable, but may be elusive. The system and method disclosed herein combines the well proven expeditor concept with the use of Natural Language Processing NLP to further enhance system efficiency. An NLP process is implemented to ensure that a request is processed using machine based processes which may improve the quality of the content of a request. NLP is used to convert a user request into a suggested structured query which may be compared to a database of queries.

NLP is used to create estimation and matching functions which may be used to determine the probability that a response to a request is available. NLP is further used to automatically categorize a query to match with a system index. Results of NLP are used to determine whether a query may be answered automatically, may be routed to an expeditor, or may be routed to a searcher.

NLP processing is implemented in a multi-layered approach. In a first layer, an unprocessed request or ‘raw query’ is passed through a series of automated processes which may improve the readability of a query, correct spelling, tokenize the query, detect named entities, determine locations, produce an annotation graph, etc., prior to the query being compared to a database of queries.

A target query is compared to a database of reference queries to determine whether a match to the query is found. If a reference query which is an exact match to a target query is found, a quality function associated with any answers associated with the matching query is evaluated, and is used to determine whether the answer should be automatically sent, and/or should be presented to a guide (e.g. and expediter) to determine whether the answer should be sent responsive to the target query.

If a reference query is not found which exactly matches a target query, reference queries which are highest ranked based on an index match to the target query may be evaluated to determine if the queries are a sufficiently close match to a target query. In at least one embodiment, reference queries which have similar scores from the index may be compared to each other to determine whether any answers associated with the reference queries may be evaluated if a reference query is determined to be a suitable match to a target query. This may allow a higher quality answer associated with a lower ranked reference query to be provided responsive to a request including the target query.

Automated analysis of a query may be used to determine whether a request is to be presented to an expediter guide, and/or may be presented to a searcher guide directly. Information such as query length, query category, keywords of a query, etc., may be used to determine whether a request is provided to an expediter, and/or may determine a toolset and/or an order of presentation of a toolset to a guide.

If a request is presented to an expediter, an expediter may modify a query associated with the request and the modified query may be used as a target query for NLP analysis of the request. An expediter may be presented with results of comparisons to a revised target query, which may allow an expeditor to select and/or review a matching query and/or answer. NLP processing may be adjusted based on whether a guide has reviewed a request.

If it is determined that a query is to be routed to an expeditor, a GUI presented to an expeditor may be based at least in part on evaluation of the type of response which an expeditor may need to provide to the query. This may significantly improve efficiency of the expeditor process resulting in better user experience. An expeditor may select an advertisement to be provided to a user, which may significantly improve targeting of an advertisement, which may be highly valuable as an advertiser may obtain the exclusive attention of a user. Further a well targeted advertisement may be provided while a user is waiting for a search result.

The system described may increase fully automated responses as a user query may be standardized using algorithmic preprocessing which may increase matching to a database of reference queries. An expediter is not required to correct common errors in punctuation, etc. which may be easily corrected automatically. An expediter may modify a query to conform to a standardized query or otherwise, which may improve a match to a reference query. If a target query is matched by a guide to a reference query, information of the matching may cause the target query to be used as a reference query subsequently.

Use of NLP algorithms has been demonstrated to greatly improve automated and human-assisted matching of a user request to answers. In the case of the ChaCha® answer service, use of blended processing including NLP processing has reduced the manpower requirements to respond to a query by an order of magnitude compared to processing by humans alone, while maintaining the same level of answer quality. For example, the median length of queries answered automatically using the new system may be equal to the median length of queries answered by human expediters given an equivalent size corpus of reference queries. Further, a percentage of queries requiring a search may be reduced by as much as eighty percent using the methods and systems described herein.

While the embodiments are described in terms of a generalized answer service, the methods and system are not so limited. The methods and systems might be implemented in a customer service operation, an internal enterprise information network, and/or any system which responds to user requests for information.

Any or all of the operations described herein may be implemented via one or more hardware components. However, the present invention is not limited to any specific implementation of an operation. For example, one or more operations discussed herein may be implemented via software executed on a device while others may be executed via a specific hardware device.

The present invention may be implemented using a program stored, for example, in a computer-readable storage medium such as a CD-ROM, etc., or using one or more specialized terminals, devices or systems that is enabled to execute operation(s) described herein. The storage or recording medium used in an embodiment can be selected from among various computer-readable media including, a disk, a DVD, an internal storage device (memory such as RAM or ROM) in a computer, etc.

As mentioned above, the embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

The many features and advantages of the claimed invention are apparent from the detailed specification and, thus, it is intended by the appended claims to cover all such features and advantages of the claimed invention that fall within the true spirit and scope of the invention. Further, since numerous modifications and changes will readily occur to those skilled in the art, it is not desired to limit the invention to the exact construction and operation illustrated and described for the disclosed embodiments, and accordingly all suitable modifications and equivalents may be resorted to, falling within the scope of the claimed invention. It will further be understood that the phrase “at least one of A, B and C” may be used herein as an alternative expression that means “one or more of A, B and C.”

What is claimed is:

1. A computer-implemented method, comprising:
modifying an original query received based on a processing applied to the query prior to performing a search; and
performing the search using the modified query and providing a response to the query as a result of the search.

2. The computer-implemented method of claim 1, wherein the processing is a natural language processing.

3. The computer-implemented method of claim 1, comprising:
determining a process to be carried out for responding to the original query based on said modifying.

4. The computer-implemented method of claim 1, wherein said modifying includes mapping the original query to a vetted query, and
using the vetted query to produce a response to the original query.

5. The computer-implemented method of claim 1, wherein said modifying includes augmenting the original query based on review by a human ambassador.

6. A computer-implemented method, comprising:
receiving a request for information;
comparing the request with a predefined query pattern;
correcting spelling;
substituting words;
removing signatures using information of stored requests;
creating automatically an annotation graph for the request;
selecting a category;
obtaining queries determined to match the annotation graph using an index of queries;
calculating a matching function comparing the queries to the annotation graph;
calculating a rating of a search result associated with the queries;
ranking the queries based on the matching function;
ranking the search results based on the rating; and
providing a highest ranked search result responsive to the request.

7. The computer-implemented method of claim 6, wherein the correcting, the substituting, the query pattern, the removing and the creating are modified based on a source of the request.

8. The computer-implemented method of claim 6, wherein the queries conform to a predetermined grammar construct.

9. The computer-implemented method of claim 6, comprising:
providing the request and an output of the comparing, correcting, substituting, removing, and creating to a human searcher;
providing to the human searcher a toolset selected based on the output; and
selecting by the human searcher a method for responding to the request.

10. The computer-implemented method of claim 9, comprising:
constructing by the human searcher a sentence; and
calculating the matching function and the rating using the sentence.

11. The computer-implemented method of claim 10, comprising:
providing a list of search results in order of the ranking to the human searcher;
the human searcher selecting a search result; and
ranking the result selected by the human searcher as the highest ranked result.

12. The computer-implemented method of claim 6, wherein the matching function comprises:
comparing a noun phrase of the stored query to a noun phrase of the annotation graph;
comparing a noun of the stored query to a noun of the annotation graph;
comparing a named entity of the stored query to a named entity of the annotation graph;
comparing a location of the stored query to a location associated with the request; and
comparing a category of the stored query to a category of the request.

13. The computer-implemented method of claim 6, wherein the rating comprises:
comparing a time stamp of an answer to a time stamp of other answers;
comparing a usage frequency of an answer to a usage frequency of other answers;
comparing a logic flag of an answer to a logic flag of other answers;
comparing a category of an answer to a category of other answers; and
combining the comparisons arithmetically.

14. A system, comprising:
a search service device receiving a search query, performing a natural language processing of the search query, comparing the search query to a corpus of requests, and determining a process for responding to the search query;
a searcher device receiving information of the search query, and providing a response to the search query; and
a database including information of search queries and search results.

15. The system of claim 14, wherein the determining includes selecting an automated process, a human assisted process, and a combined human assisted and automated process;
wherein the comparing is based on word frequency; and
wherein the natural language processing is adapted to information of a device submitting the request.

16. A computer readable storage medium storing therein a program for causing a computer to execute an operation including responding to an inquiry, comprising:
receiving the inquiry;
processing the inquiry based on semantic rules;
ranking interrogatives using a result of processing of the inquiry;
determining a procedure; and
initiating the procedure.

17. The computer readable storage medium of claim 16 wherein the operation comprises:
comparing the inquiry to a template associated with an automated process;
substituting a word indicated in the inquiry with a synonym of the word;
replacing a word indicated in the inquiry with a highest ranked word from a lexicon;
selecting a lexicon for the processing;
removing leading and trailing text from the inquiry which matches a previous inquiry; and
associating a category with the inquiry using word frequency associated with an index.

18. The computer readable storage medium of claim 16 wherein the operation comprises:
receiving a first message from a first source;
receiving a second message from a second source; and
determining the inquiry based on the first message and the second message.

19. The computer readable storage medium of claim 16 wherein the operation comprises:
ranking interrogatives using the inquiry.

20. The computer readable storage medium of claim 16 wherein the operation comprises:
determining a probability that the procedure is an automated procedure;
presenting the inquiry and the result to a first human guide;
providing a suggested response to the first human guide; and
performing a procedure indicated by the first human guide.

21. The computer readable storage medium of claim 20 wherein the operation comprises:
transferring by the first human guide the inquiry to a second human guide; and
adjusting a parameter used to determine the probability based on the procedure indicated by the first human guide.

22. The computer readable storage medium of claim 20 wherein the operation comprises:
modifying the inquiry by the first human guide;
adjusting a parameter of the ranking; and
ranking the interrogatives based on the modified inquiry.

23. The computer readable storage medium of claim 16, wherein the operation comprises:
determining the procedure automatically; and
initiating the procedure by a human guide.

24. The computer readable storage medium of claim 16, wherein the operation comprises:
determining a probability that an automated response may be provided; and
selecting a human guide to respond to the inquiry based on the probability.

25. The computer readable storage medium of claim 16, wherein the operation comprises:
receiving a first message from a first source;
receiving a second message from a second source;
determining the inquiry based on the first message and the second message;
comparing the inquiry to a template associated with an automated process;
substituting a word indicated in the inquiry with a synonym of the word;
replacing a word indicated in the inquiry with a highest ranked word from a lexicon;
selecting a lexicon for the processing;
removing leading and trailing text from the inquiry which matches a previous inquiry; and
associating a category with the inquiry using word frequency associated with an index;
ranking interrogatives using the inquiry;
determining a probability that an automated response may be provided;
selecting a human guide to respond to the inquiry based on the probability;
presenting the inquiry and the result to a first human guide;
providing a suggested response to the first human guide;
performing a procedure indicated by the first human guide;
transferring by the first human guide the inquiry to a second human guide;
adjusting a parameter used to determine the probability based on the procedure indicated by the first human guide
modifying the inquiry by the first human guide;
ranking the interrogatives based on the modified inquiry;
ranking a plurality of responses associated with the interrogatives based on a selection by a third human guide, temporal information, and location information;
receiving a selection by the first human guide; and
modifying a ranking of the plurality of responses based on the selection.
